(19) United States
(12) Patent Application Publication
(10) Pub. No.: US 2005/0237642 A1
(43) Pub. Date: Oct. 27, 2005

(54) Decentering optical system, optical transmitting device, optical receiving device, and optical system

(76) Inventors: Koichi Takahashi, Tokyo (JP); Yoshinori Arimoto, Tokyo (JP)

Correspondence Address: KENYON & KENYON, 1500 K STREET NW, SUITE 700, WASHINGTON, DC, 20005, US

(21) Appl. No.: 11/065,245

(22) Filed: Feb. 25, 2005

(30) Foreign Application Priority Data
Mar. 1, 2004 (JP) P 2004-056402

(51) Int. Cl. G02B 5/04

(52) U.S. Cl. 359/831; 359/629

(57) ABSTRACT

A decentering optical system which takes a substantially parallel beam as input light, including a prism whose refractive index is greater than 1, and in which: at the boundary surface of the prism, at least five optical surfaces, which are arranged so as to be mutually decentering or inclined, are formed, in order along one optical path which the input light pursues, as a first surface, a second surface, a third surface, a fourth surface, and a fifth surface; at least two among these five optical surfaces are rotationally asymmetric surfaces; and, upon an optical path along which the input light proceeds in order from the first surface to the fifth surface and is emitted to the exterior of the prism, along with at least one real image being formed interior of the prism, an exit pupil is formed at the exterior of the prism.

### BACKGROUND OF THE INVENTION

Priority is claimed on Japanese Patent Application No. 2004-56402, filed Mar. 1, 2004, the contents of which are incorporated herein by reference.

1. Field of the Invention

The present invention relates to a decentering optical system, to an optical transmitting device, to an optical receiving device, and to an optical system. In particular, the present invention relates to a decentering optical system, to an optical transmitting device, to an optical receiving device, and to an optical system, which branch off an incident luminous flux being substantially parallel and being used in free space optical communication, and which detect the direction of incidence with a plurality of optical detectors whose resolving powers are mutually different from one another.

2. Description of Related Art

In the past, as an optical antenna which is used for free space optical communication and the like, there has per se been known a telescopic optical system, and in particular a telescopic optical system which includes a reflection optical system. As such a reflection optical system, in the field of, for example, astronomy or the like, there are per se known reflection optical systems of the Cassegrain type or of the Gregorian type which use a combination of a primary mirror and a secondary mirror, or the like.

The mirrors which are used in these reflection optical systems are arranged upon a common axis. On the other hand, various kinds of optical system have been considered which are decentering optical systems of the mirror type or the prism type, in which a plurality of reflective surfaces are combined together so as to be mutually decentering or to slant.

For example, on pages 3 to 8 and in FIGS. 1 and 3 of Japanese Patent Application, First Publication No. 2003-5074, there is disclosed a reflective type optical element which has three reflective surfaces. In this reflective type optical element, a structure is employed in which, after having performed intermediate imaging in a region which is surrounded by a reflective surface, imaging is performed at the outside of the reflective type optical element.

In this reflective type optical element, in the region which is surrounded by the reflective surface, it is arranged to fold up the optical path by the reference axis, which is the path of a light beam from the center of the body surface which is reflected by each of the reflective surfaces and then passes through the center of the pupil, being crossed over at least twice.

For an optical antenna for free space optical communication, it is extremely desirable to be provided with a plurality of optical detectors for coarse tracking and fine tracking and the like, and/or to perform both transmission and reception of signals for free space optical communication.

Furthermore, for use in an optical antenna, it is necessary to construct an optical system of which the incident pupil is large and moreover the focal length is long.

### SUMMARY OF THE INVENTION

(A) A decentering optical system according to the present invention takes a substantially parallel beam as input light, and includes a prism whose refractive index is greater than 1. At the boundary surface of the prism, at least five optical surfaces, which are arranged so as to be mutually decentering or inclined, are formed, in order along one optical path in which the input light pursues, as a first surface, a second surface, a third surface, a fourth surface, and a fifth surface. At least two among the five optical surfaces are rotationally asymmetric surfaces. Upon an optical path along which the input light proceeds in order from the first surface to the fifth surface and is emitted to the exterior of the prism, along with at least one real image being formed interior of the prism, an exit pupil is formed at the exterior of the prism.

(B) Another decentering optical system according to the present invention takes a substantially parallel beam as input light, and includes a prism whose refractive index is greater than 1. At the boundary surface of the prism, at least five optical surfaces, which are arranged so as to be mutually decentering or inclined, are formed, in order along one optical path in which the input light pursues, as a first surface, a second surface, a third surface, a fourth surface, and a fifth surface. At least one among the five optical surfaces is a splitting surface which splits the optical path of the input light into a transmission optical path and a reflection optical path. The reflection optical path is an optical path along which the input light proceeds in order from the first surface to the fifth surface and is emitted to the exterior of the prism. At least one real image is formed within the prism upon the reflection optical path or upon the transmission optical path.

(C) With the decentering optical system according to (B) above, a luminous flux which has been emitted to the exterior of the prism may form an exit pupil.

(D) With the decentering optical system according to (C) above, at least one real image may be formed upon the reflection optical path and interior of the prism. The exit pupil may be formed upon the reflection optical path and moreover exterior to the prism. And another real image may be formed upon the transmission optical path and moreover external to the prism.

(E) With the decentering optical system according to (B) above, the axial principal ray of the luminous flux which has been reflected by the splitting surface may pursue an optical path which crosses over at least two of the axial principal rays in the interior of the prism.

(F) With the decentering optical system according to (B) above, the first surface may be a transmission surface which transmits the input light to the interior of the prism. The second surface may be an internal reflection surface which reflects the luminous flux that has passed through the first surface. The third surface may be an internal reflection surface which reflects the luminous flux that has been reflected from the second surface. The fourth surface may be the splitting surface which splits the optical path of the luminous flux which has been reflected from the third surface into the transmission optical path and the reflection optical path. The fifth surface may be a transmission surface which passes the luminous flux pursuing along the reflection optical path. At least two of the first surface through the fifth surface may be rotationally asymmetric surfaces. Along with the at least one real image in the interior of the prism being formed upon the reflection optical path, another real image may be formed upon the transmission optical path and moreover on the exterior of the prism.

(G) With the decentering optical system according to (A) above, the axial principal ray towards the fourth surface which has been reflected from the third surface and the axial principal ray towards the fifth surface which has been reflected from the fourth surface may both cross over the axial principal ray towards the second surface which has passed through the first surface.

(H) With the decentering optical system according to (A) above, the second surface may include a rotationally asymmetric surface which is endowed with a positive power upon a plane which includes at least all the axial principal rays which are in the interior of the prism.

(I) With the decentering optical system according to (A) above, the third surface may include a rotationally asymmetric surface which is endowed with a negative power upon a plane which includes at least all the axial principal rays which are in the interior of the prism.

(J) With the decentering optical system according to (A) above, the at least one real image which is formed in the interior of the prism may be formed between the fourth surface and the fifth surface.

(K) With the decentering optical system according to (A) above, when the paraxial focal length in the interior of the prism to the at least one real image is termed F, and the air converted length from the imaging position of the real image to the exit surface of the prism is termed L, the following Equation (1) may be satisfied:
0.01≦L/F≦0.3 (1)

(L) With the decentering optical system according to (A) above, when the paraxial focal length in the interior of the prism to the at least one real image is termed F, the following Equation (2) may be satisfied:
60 (mm)≦F≦500 (mm) (2)

(M) With the decentering optical system according to (A) above, when the paraxial focal length in the interior of the prism to the at least one real image is termed F, and the entrance pupil diameter is termed D, the ratio F/D may satisfy the following Equation (3):
2≦F/D≦15 (3)

(N) With the decentering optical system according to (A) above, there may be further included at least one light condensing device which condenses a luminous flux which has been emitted from the prism at a light reception surface.

(O) With the decentering optical system according to (B) above, there may be further included a lens which is disposed in the neighborhood of the exit surface of the reflection optical path, and which condenses or diverges a luminous flux which has been exited from the exit surface.

(P) With the decentering optical system according to (O) above, both the exit surface of the reflection optical path and one lens surface of the lens may be planar. And the exit surface and the lens may be arranged so that their plane surfaces confront one another.

(Q) With the decentering optical system according to (O) above, the exit surface of the reflection optical path and the lens may be mutually joined together.

(R) An optical transmitting device of the present invention includes: a decentering optical system according to (A) above; and a light source section which emits a substantially parallel beam.

(S) With the optical transmitting device according to (R) above, there may be further included an optical path synthesis device for making the substantially parallel beam which is emitted from the light source section to be incident upon the exit pupil.

(T) With another optical transmitting device according to the present invention, there may be included: a decentering optical system according to (B) above; and a light source section which emits a substantially parallel beam.

(U) An optical receiving device according to the present invention includes: a decentering optical system according to (A) above; and at least one position detection sensor which receives a luminous flux which has been emitted to the exterior of the prism of the decentering optical system, and detects the light reception position thereof.

(V) Another optical receiving device according to the present invention includes: a decentering optical system according to (A) above; at least one light reception element which receives a luminous flux which has been emitted to the exterior of the prism of the decentering optical system; and an input signal controller which is connected to the light reception element.

(W) An optical system according to the present invention includes: an optical transmitting device which emits substantially parallel light; and an optical receiving device, which is disposed so as to confront the optical transmitting device with a certain distance between them, which receives the substantially parallel light as input light, and which includes a decentering optical system according to (A) above.

(X) With the optical system according to (W) above, the optical receiving device may include at least one light reception surface which is a position detection sensor. And the optical system may perform optical acquisition and tracking based upon a position signal from the position detection sensor.

(Y) With the optical system according to (W) above, the optical transmitting device may include an output signal controller. The optical receiving device may include an input signal controller. Free space optical communication may be performed by modulating a communication signal and sending and receiving it.

### BRIEF DESCRIPTION OF THE DRAWINGS

FIG. 1 is a figure for explanation of the decentering optical system according to the first embodiment of the present invention, and is an optical path diagram including, in cross section, the optical path of an axial principal ray.

FIGS. 2A and 2B are optical path diagrams in which, for this decentering optical system, the reflection optical path and the transmission optical path are shown separately from one another.

FIG. 3 is an optical path diagram for explanation of a first variant example of this decentering optical system, and shows a cross section which includes the optical path of the axial principal ray.

FIGS. 4A and 4B are figures for explanation of the second embodiment of the present invention and of a variant example thereof, and are optical path diagrams which include, in cross section, the optical path of an axial principal ray.

FIG. 5 is a figure for explanation of the third embodiment of the present invention, and is an optical path diagram which includes, in cross section, the optical path of an axial principal ray.

FIGS. 6A and 6B are optical path diagrams in which, for this decentering optical system, the reflection optical path and the transmission optical path are shown separately from one another.

FIG. 7 is a schematic cross sectional view for explanation of the general structure of an optical acquisition and tracking device according to the fourth embodiment of the present invention.

FIGS. 8A through 8D are horizontal aberration diagrams of an optical path 1 in a first preferred numerical value embodiment of the present invention.

FIGS. 9A through 9D are, similarly, horizontal aberration diagrams for a case in which the angle of view is different.

FIGS. 10A through 10D are, similarly, horizontal aberration diagrams for a case in which the angle of view is different.

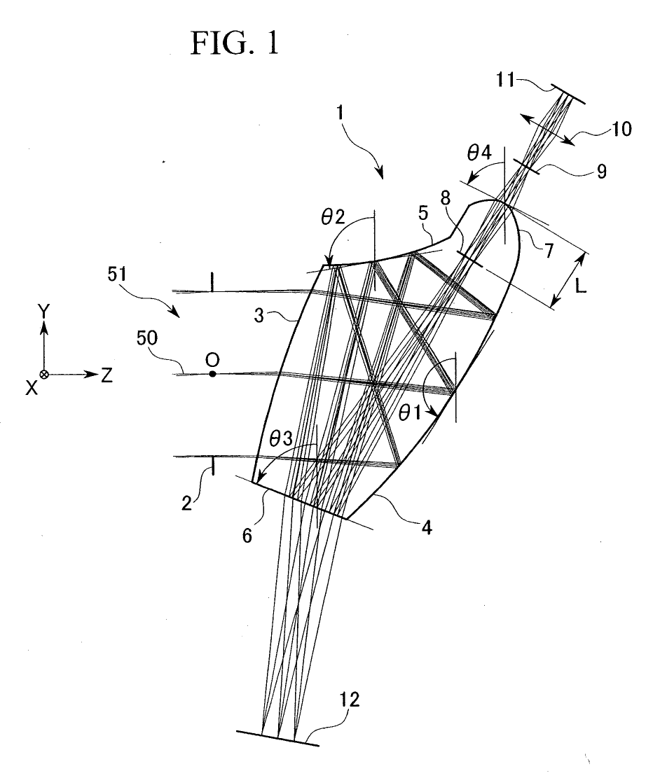

FIGS. 1A through 1D are horizontal aberration diagrams of an optical path 2 in the first preferred numerical value embodiment of the present invention.

FIGS. 12A through 12D are, similarly, horizontal aberration diagrams for a case in which the angle of view is different.

FIGS. 13A through 13D are, similarly, horizontal aberration diagrams for a case in which the angle of view is different.

FIGS. 14A through 14D are horizontal aberration diagrams of an optical path 1 in a second preferred numerical value embodiment of the present invention.

FIGS. 15A through 15D are, similarly, horizontal aberration diagrams for a case in which the angle of view is different.

FIGS. 16A through 16D are, similarly, horizontal aberration diagrams for a case in which the angle of view is different.

### DETAILED DESCRIPTION OF THE INVENTION

In the following, various embodiments of the present invention will be explained with reference to the appended drawings. It should be understood that, in all these drawings, to members and assemblies which are the same as or which correspond to one another, the same reference symbols are appended, and repetitive explanation thereof will be omitted.

### The First Embodiment

The decentering optical system according to the first embodiment of the present invention will now be explained in the following.

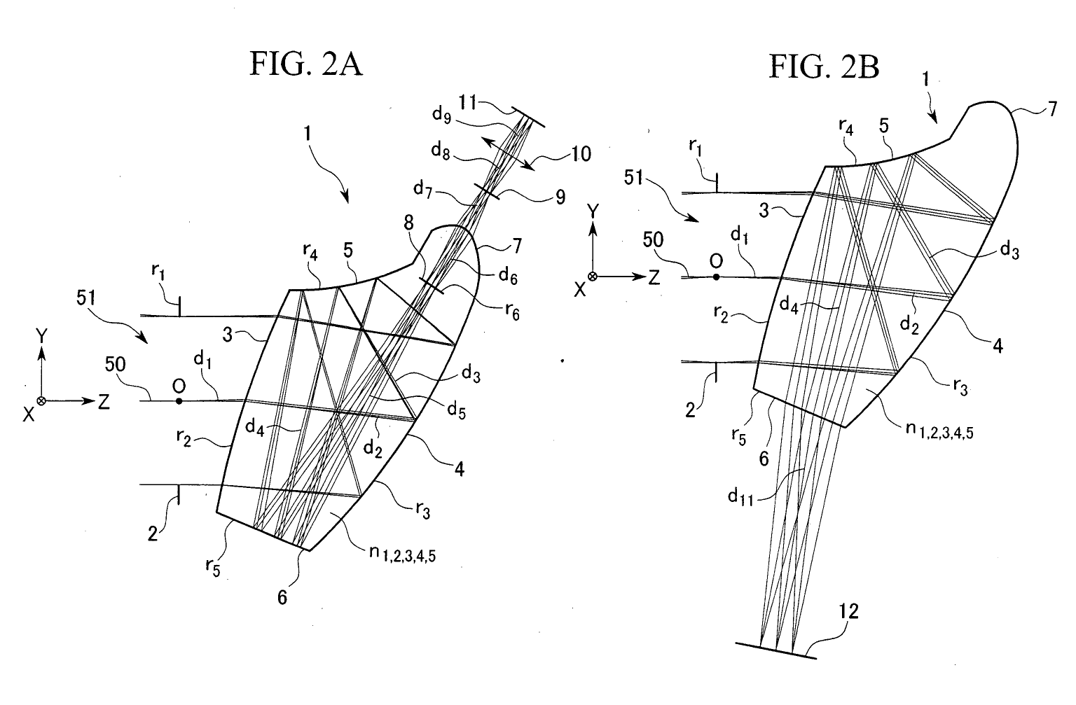

FIG. 1 is a figure for explanation of one example of this decentering optical system according to the first embodiment of the present invention, and is an optical path diagram which includes, in cross section, the optical path of an axial principal ray. FIG. 1 is a drawing in which the two optical paths are drawn as being mutually overlapped. FIGS. 2A and 2B are figures in which these optical paths are shown separately from one another. The various coordinate axes which are shown in these FIGS. 1, 2A, and 2B indicate coordinate systems which are used in the calculations for preferred numerical value embodiments which will be described hereinafter, and the direction of progression of the luminous flux agrees with the Z axis direction, while the depth direction away from the viewer behind the surface of the drawing paper agrees with the X axis direction. In FIG. 2A, light beams of which the angles of incidence are 0° and ±0.4° (around an axis perpendicular to the drawing paper) are shown as a main light beam and two subsidiary light beams. In FIG. 2B, light beams of which the angles of incidence are 0° and ±10 (again, around an axis perpendicular to the drawing paper) are shown as a main light beam and two subsidiary light beams.

A prism 1 according to the first embodiment of the present invention will now be explained.

As shown in FIG. 1, by receiving an incident luminous flux 51 (input light) which is a substantially parallel beam from the leftward direction as seen in the figure, this prism 1, upon one optical path, constitutes an effectively afocal optical system which emits a substantially parallel beam, and, upon another optical path, constitutes an imaging optical system which creates a real image upon an image surface 12 external to the prism. The reference symbol 2 in FIG. 1 denotes an aperture iris which forms an entrance pupil. Furthermore, the reference symbol 10 in FIG. 1 denotes the position of an ideal lens which is disposed in order to evaluate the aberration of the effectively afocal optical system. The axial principal ray 50 is a light beam which passes through the center of the aperture iris 2 at an angle of incidence of 0°, and whose direction is changed as it arrives at each of the optical surfaces, so that it constitutes a reference axis for this optical system.

As for the material of the prism 1, it is made from a medium whose refractive index is greater than 1. As this kind of medium, for example, glass or synthetic resin may be used.

At the boundary surface between the medium of the prism 1 and the air, at least the following five optical surfaces are formed: a transmission surface 3, a reflective surface 4 (an internal reflection surface), a reflective surface 5 (another internal reflection surface), a splitting surface 6, and a transmission surface 7. Each of these optical surfaces is endowed with an appropriate curvature for its task, and, when seen in cross sections which extend vertical to the drawing paper, they are formed as solid bodies of substantially pillar shapes, having substantially the same cross sectional shape.

These five optical surfaces are arranged in the following order, in the anticlockwise externally circumferential direction as seen in the figure: the transmission surface 3, the reflective surface 4, the reflective surface 5, the splitting surface 6, and the transmission surface 7. Between the transmission surface 7 and the reflective surface 5, there is formed a boundary surface which is not an optical surface.

After an incident luminous flux 51 has passed along one optical path which is formed within this prism 1 and has arrived at the transmission surface 3, the reflective surface 4, the reflective surface 5, the splitting surface 6, and the transmission surface 7 in that order, a substantially parallel beam is emitted to the exterior of the prism 1.

In the following explanation, the transmission surface 3, the reflective surface 4, the reflective surface 5, the splitting surface 6, and the transmission surface 7 will be also termed the “first surface”, the “second surface”, the “third surface”, the “fourth surface”, and the “fifth surface”, according to their order along this optical path.

With regard to the arrangement of these various optical surfaces in the above described structure, the first surface and the second surface do not adjoin one another in the externally circumferential direction, but, rather, the third surface, the fifth surface, and fourth surface are present within a region which is sandwiched between the first surface and the second surface. Furthermore, the third surface and the fourth surface do not adjoin one another in the externally circumferential direction, but, rather, the first surface, the fourth surface, and the fifth surface are present within a region which is sandwiched between the third surface and the fourth surface. Yet further, the fourth surface and the fifth surface do not adjoin one another in the externally circumferential direction, but, rather, the first surface, the third surface, and the second surface are present within a region which is sandwiched between the fourth surface and the fifth surface.

As a result, between the first surface and the second surface within the prism 1, an optical path from the third surface towards the fourth surface exists, and also an optical path from the fourth surface towards the fifth surface exists. Due to this, the axial principal ray along the optical path from the first surface towards the second surface is in a mutually intersecting positional relationship with regard to the axial principal rays along these two optical paths. In the same manner, between the fourth surface and the fifth surface within the prism 1, an optical path from the first surface towards the second surface exists, and also an optical path from the second surface towards the third surface exists. Due to this, the axial principal ray along the optical path from the fourth surface towards the fifth surface is in a mutually intersecting positional relationship with regard to the axial principal rays along these two optical paths.

In other words, upon these optical paths, the optical path from the first surface to the fourth surface is folded up into a three cornered shape within the prism 1, and furthermore the optical path from the fourth surface toward the fifth surface crosses over the optical path from the first surface towards the second surface and also crosses over the optical path from the second surface towards the third surface, and then is emitted to the exterior of the prism 1. In other words, there exist a first three cornered shape which is formed by the optical path from the first surface to the fourth surface, and a second three cornered shape which is formed by the optical path from the second surface to the fifth surface.

Accordingly, by housing the optical path from the fourth surface towards the fifth surface within the prism 1, it is possible to obtain a decentering optical system which has been made more compact, as compared with a prior art type prism in which the optical path is folded up into only a single three cornered shape, even though this is an optical system of which the optical path length becomes long because the focal length is long.

In this first embodiment of the present invention, since the axial principal ray 50 is within the same plane (within the Y-Z plane which will be subsequently described, i.e., within the plane of the drawing paper as seen in the figure), even if the angle of incidence within this plane changes, the optical path still crosses over itself as described above. On the other hand, if the incident luminous flux 51 has an angle of incidence in a plane which is orthogonal to the plane of the drawing paper (within the X-Z plane which will be subsequently described), then it will pursue a three dimensional optical path. In this case, the portion which has been explained in the above as an intersection is in a skewed positional relationship, so that, when the optical path is projected upon the plane of the drawing paper, it intersects with itself, or, to express this differently, it will be understood that the optical path is compactly folded up in the same manner as described above, within the range of the thickness of the prism 1 in the direction which is perpendicular to the drawing paper.

In the following, in order to simplify the explanation, the discussion will be performed for a two dimensional optical path; but, according to requirements, a three dimensional optical path will be explained. If no particular exception is specified, any statement which is made herein for a two dimensional optical path can easily be extended to a three dimensional optical path as well.

In this first embodiment of the present invention, for at least two among the five optical surfaces, there are employed freely curved surfaces, which are curved surfaces which are rotationally asymmetric. First, the coordinate system and the freely curved surface Equations which are used for expressing this type of rotationally asymmetric surface in this decentering optical system will be explained.

In this coordinate system, as shown in FIGS. 1, 2A, and 2B, in the light beam tracking from the body side towards the aperture iris 2 and the prism 1, the incident side optical axis is formed as being the light beam, in the axial principal ray 50, which is orthogonal to the center of the aperture iris 2 which forms the iris surface, and which arrives at the center of the transmission surface 3 of the prism 1. During light beam tracking, the center of the aperture iris 2 is taken as being the origin 0 of the decentering optical surface of the decentering optical system (however, in order to avoid overlapping with the optical path, the coordinate axes as seen in the figure are displaced from this origin position); the direction along the incident side optical axis is taken as being the Z axis direction; the direction from the side of the body towards the surface which is formed by the aperture iris 2 of this decentering optical system is taken as being the positive direction of the Z axis; the plane of the drawing paper is taken as being the Y-Z plane; the direction perpendicular to the surface of the drawing paper and away from the viewer is taken as being the positive direction of the X axis; and that axis is taken as the Y axis, for which the X axis, this Y axis, and the Z axis together constitute a right handed orthogonal coordinate system.

As for the angles of inclination, if they are respectively taken as α, β, and γ when the X axis, the Y axis, and the Z axis are taken as centers, then positive values for the angles of inclination α and β are defined as being angles in the anticlockwise direction with respect to the positive directions of the X axis and the Y axis, and positive values for the angle of inclination γ are defined as being angles in the clockwise direction with respect to the positive direction of the Z axis.

Furthermore, when each of the optical surfaces is to be expressed in a coordinate system, that coordinate system is defined by, when the axial principal ray 50 has been light beam tracked in order from the body in the direction towards the image surfaces, taking the point at which the optical surface and the axial principal ray 50 cross over as the origin, and, in the state with the X axis being oriented in the vertical direction with respect to the drawing paper, rotating the Y axis and the Z axis so that the Z axis is made to agree with the axial principal ray 50.

As for the directions of rotation through α, β, and γ of the central axis of the surface: first, the central axis of the surface and its XYZ orthogonal coordinate system are rotated through the angle of α in the anticlockwise direction around the X axis; next, along with rotating the central axis of the surface which has thus been rotated through the angle of β in the anticlockwise direction about the Y axis of the new coordinate system, this coordinate system which has thus been once rotated is also rotated through the angle of β in the anticlockwise direction about the Y axis as well; and then the central axis of the surface which has thus been twice rotated is rotated through the angle of γ in the clockwise direction about the Z axis of the new coordinate system.

As for the shape of the rotationally asymmetric curved surface which is utilized in this first embodiment of the present invention, for example, it may be described by the freely curved surface Equation which is expressed in Definition Equation (a) given below. The Z axis of Definition Equation (a) becomes the axis of the freely curved surface.

$$Z = \frac{( {r}^{2} / R )}{[ 1 + \sqrt{\{ 1 - ( 1 + k ) {( r / R )}^{2} \}} ]} + {\sum }_{j = 1}^{66} {C}_{j} {X}^{m} {Y}^{n} \qquad ( a )$$

Here, the first term in Definition Equation (a) is a spherical surface term, and the second term is a freely curved surface term. In the spherical surface term, R is the paraxial curvature radius of the apex, k is a unique constant (a circular conical constant), and r=√(X²+Y²).

The freely curved surface term will be:

$${\sum }_{j = 1}^{66} {C}_{j} {X}^{m} {Y}^{n} = {C}_{1} + {C}_{2} X + {C}_{3} Y + {C}_{4} {X}^{2} + {C}_{5} XY + {C}_{6} {Y}^{2} + {C}_{7} {X}^{3} + {C}_{8} {X}^{2 } Y + {C}_{9} {XY}^{2} + {C}_{10} {Y}^{3} + {C}_{11} {X}^{4} + {C}_{12} {X}^{3} Y + {C}_{13} {X}^{2} {Y}^{2} + {C}_{14} {XY}^{3} + {C}_{15} {Y}^{4} + {C}_{16} {X}^{5} + {C}_{17} {X}^{4} Y + {C}_{18} {X}^{3} {Y}^{2} + {C}_{19} {X}^{2} {Y}^{3} + {C}_{20} {XY}^{4} + {C}_{21} {Y}^{5} + {C}_{22} {X}^{6} + {C}_{23} {X}^{5} Y + {C}_{24} {X}^{4} {Y}^{2} + {C}_{25} {X}^{3} {Y}^{3} + {C}_{26} {X}^{2} {Y}^{4} + {C}_{27} {XY}^{5} + {C}_{28} {Y}^{6} + {C}_{29} {X}^{7} + {C}_{30} {X}^{6} Y + {C}_{31} {X}^{5} {Y}^{2} + {C}_{32} {X}^{4} {Y}^{3} + {C}_{33} {X}^{3} {Y}^{4} + {C}_{34} {X}^{2} {Y}^{5} + {C}_{35} {XY}^{6} + {C}_{36} {Y}^{7}$$

where the Cⱼ (is an integer greater than 1) are coefficients.

The above described freely curved surface, generally, does not have X-Z or Y-Z planes of symmetry; but, in this first embodiment of the present invention, by making all of the terms for which the power of X is odd being zero, it becomes a freely curved surface in which just one plane of symmetry exists parallel to the Y-Z plane. For example, this is possible by making all of the coefficients C₂, C₅, C₇, C₉, C₁₂, C₁₄, C₁₆, C₁₈, C₂₀, C₂₃, C₂₅, C₂₇, C₂₉, C₃₁, C₃₃, C₃₅, . . . of each terms in the above described Definition Equation (a) being zero.

Furthermore, the aspheric surface which is used in this first embodiment is a rotationally symmetric aspheric surface which is defined by the following Definition Equation (b):

$$Z = \frac{{ch}^{2}}{1 + \sqrt{1 - ( 1 + k ) {c}^{2} {h}^{2}}} + {Ah}^{4} + {Bh}^{6} + {Ch}^{8} + … \qquad ( b )$$

Here, h=√(X²+Y²), c is the paraxial curvature radius of the apex, k is a unique constant (a circular conical constant), and A, B, C, D, . . . . are, respectively, the aspheric surface coefficients of the fourth power, the sixth power, the eighth power, the tenth power, . . . . The Z axis of this Definition Equation (b) becomes the axis of the rotationally asymmetric surface.

In the following, each of the optical surfaces will be explained in more detail.

The transmission surface 3 (the first surface) is an optical surface which, by being disposed eccentrically or at an angle around the X axis with respect to the axial principal ray 50, refracts the incident luminous flux 51, thus causing the axial principal ray 50 to be bent in the direction around the X axis. It should be understood that the amount of this eccentricity is expressed as the angle of inclination 01 which is subtended between the contact plane at the point of intersection between the axial principal ray 50 and the second surface, and the plane which includes the aperture iris 2 (refer to FIG. 1; in the other examples and other embodiments which will be described hereinafter, it is defined in the same manner).

This transmission surface 3 may, for example, be a plane, which is easy to manufacture; but it is more desirable for it to be endowed with a positive power, in order to make aberration compensation easier, by converting the incident luminous flux 51 into a convergent luminous flux, and thus making it possible to reduce the power of the other optical surfaces.

If the transmission surface 3 is endowed with a positive power, then, in order to reduce the decentering aberration, it is more desirable to make it as a freely curved surface which is a rotationally asymmetric curved surface which is asymmetric in the direction of inclination, while being symmetric with respect to the Y-Z plane.

The reflective surface 4 (the second surface) is made as a surface which is endowed with the principal positive power in this decentering optical system, and it is arranged to be decentering with respect to the axial principal ray 50 which has been bent by the transmission surface 3, so as to be able to fold up the optical path towards the side of the third surface.

This reflective surface 4 may be manufactured by applying an appropriate reflective coating layer to the boundary surface of the medium, which has been processed into a predetermined curved surface. If possible, it will also be acceptable to omit the reflective coating layer, such that the luminous flux which is incident from the first surface upon this reflective layer 4 being totally reflected.

This reflective surface 4 can be endowed with a large positive power, even though it is of comparatively low curvature, since it is made as an internal reflection surface which reflects the luminous flux internally to the medium, whose refractive index is greater than 1.

On the other hand, since the reflective surface is a curved reflective surface which is endowed with a positive power, aberration due to its eccentricity, in other words decentering aberration, takes place. In order to compensate this decentering aberration, it is desirable for the reflective surface 4 to be made as a rotationally asymmetric surface.

The reflective surface 5 (the third surface) is arranged to be decentering or inclined with respect to the axial principal ray 50 of the converging light, so as to be able to fold up the converging light which has been reflected from the reflective surface 4 towards the side of the fourth surface. The processing for production of the reflective surface 5 may be performed in the same manner as for the reflective surface 4.

The amount of eccentricity or inclination of this reflective surface 5 is set so that, if the angle of inclination which is subtended between the contact plane at the point of intersection between the axial principal ray 50 and the reflective surface 5 and the plane which includes the aperture iris 2 is denoted by θ2 (refer to FIG. 1; in the other examples and other embodiments which will be described hereinafter, it is defined in the same manner), then the relationship between the angles of inclination θ1 and θ2 satisfies the following Equation (4):
30°≦|θ2−θ1|≦80° (4)

As for the surface shape of this reflective surface 5, it is endowed with a negative power, in order to compensate the spherical aberration and the coma aberration which are generated at the transmission surface 3 and the reflective surface 4. Due to this, it is possible to improve the Petzbar sum of the off-axis luminous flux. Accordingly, it is possible to obtain a satisfactory imaging performance, even if the angle of view of the input light is large.

In order to make the powers of the other optical surfaces small, the reflective surface 5 may be endowed with a positive power. In this case, this reflective surface 5 can share its power with, for example, the reflective surface 4. In this case, it becomes possible to condense the input light while reducing the aberration which is generated by each of these surfaces. Furthermore, it would also be possible to employ a plane reflective surface, which is easy to manufacture.

It should be understood that, if the reflective surface 5 is endowed with a certain power, it is desirable to employ a rotationally asymmetric surface for this reflective surface 5, in order to compensate the decentering aberration more satisfactorily.

The splitting surface 6 (the fourth surface) is an optical surface which splits the luminous flux which has been reflected from the reflective surface 5 into reflected light, which is reflected internally towards the transmission surface 7, and transmitted light, which is transmitted through the splitting surface 6 to the exterior of the prism 1 and forms an image at an image surface 12; and it is arranged so as to be decentering or inclined with respect to the axial principal ray of the luminous flux which is incident. This amount of eccentricity or inclination is expressed by the angle of inclination 03 which is subtended between the contact plane at the point of intersection of the axial principal ray 50 and the splitting surface 6, and the plane which includes the aperture iris 2 (refer to FIG. 1; in the other examples and other embodiments which will be described hereinafter, it is defined in the same manner). In the following, the optical paths of this reflected light and transmitted light will be termed, respectively, the reflection optical path and the transmission optical path.

Upon the reflection optical path, due to the powers of the first through the third surfaces and of the reflection aspect of the fourth surface, a primary image plane 8 (at least one real image) is defined in the interior of the prism 1 on the near side of the transmission surface 7. In other words, if the air converted length from the primary image plane 8 to the transmission surface 7 is termed L, L≧0.

Furthermore, if the paraxial focal length in the interior of the prism 1 from the transmission surface 3 to the primary image plane 8 is termed F, then the relationship expressed by the following Equation (1) holds:
0.01≦L/F≦0.03 (1)

Here, it is desirable for the paraxial focal length F to satisfy the following Equation (2):
60 (mm)≦F≦500 (mm) (2)

Furthermore, if the entrance pupil diameter is termed D, it is desirable for the following Equation (3) to be satisfied:
2≦F/D≦15 (3)

On the other hand, upon the transmission optical path, the luminous flux which has passed through the transmission surface 7 forms a real image (another real image) at the image surface 12.

The splitting surface 6 may be made by performing surface processing upon the boundary surface of the medium, such as reflection coating, half mirror coating, or the like, while controlling the reflection ratio with respect to light which is internally incident.

Furthermore, in cases such as, for example, when it is not necessary for the reflection ratio to be made very high, or the like, it would also be acceptable to omit the surface processing such as reflection coating, half mirror coating, or the like, so that the optical path is split by the reflection which takes place due to the difference between the refractive index of the medium and the refractive index of the air. In this case, there is the beneficial aspect that it is possible to manufacture the device at a cheaper price, since it is not necessary to perform the surface processing, which is laborious.

As for the surface shape of the splitting surface 6, according to requirements, it is possible to employ a surface which includes a convex surface or a concave surface towards the exterior side of the prism 1, or a plane surface or a rotationally asymmetric surface, or the like.

If a surface shape which defines a convex surface towards the exterior side of the prism 1 is employed, then it is possible for the optical path of the reflected light to have a focal length which is short as compared with the optical path of the transmitted light, since, normally, the power which is obtained with a single surface is larger upon the reflection side. In this case, for example, it becomes simple and easy to cause the light which is reflected from the splitting surface 6 to be imaged within the medium, and to ensure that it is imaged in the neighborhood of the transmission surface 7.

On the other hand, if a surface shape which defines a concave surface towards the exterior side of the prism 1 is employed, then it is possible for the optical path of the reflected light to have a focal length which is long as compared with the optical path of the transmitted light. In this case, it is possible to cause the reflected light to be imaged comparatively far away.

It should be understood that, if the surface shape of the splitting surface 6 is endowed with a certain power, as is the case with a convex surface or with a concave surface, then it is desirable to employ a rotationally asymmetric surface, in order to compensate the decentering aberration.

If a plane is employed as the surface shape for the splitting surface 6, it is possible to make the imaging performances for reflected light and the transmitted light to be substantially equivalent to one another. Furthermore, when a planar surface is employed for the splitting surface 6, if the splitting surface 6 is processed by cutting process, the cutting process itself will be a planar processing, while, if the splitting surface 6 is processed by molding process, the molding process itself will be a planar processing. Accordingly, the manufacturing process becomes simple, so that a reduction in cost can be anticipated.

The transmission surface 7 (the fifth surface) is an optical surface for transmitting the light which has been reflected from the splitting surface 6 and emitting it to the exterior of the prism 1, and for forming an exit pupil 9. This transmission surface 7 is disposed substantially parallel to the splitting surface 6, or decentering or inclined at a shallow angle thereto. In concrete terms, when this amount of eccentricity or inclination is expressed by the angle of inclination θ4 which is subtended between the contact plane at the point of intersection between the axial principal ray 50 and the transmission surface 7, and the plane which includes the aperture iris 2 (refer to FIG. 1; in the other examples and the other embodiments which will be described hereinafter, it is defined in the same manner), then it is arranged for the relationship between the angles of inclination θ3 and θ4 to satisfy the following Equation (5):
|θ4−θ3|≦30° (5)

The luminous flux which has been emitted from the transmission surface 7 need not necessarily be a parallel beam, provided that it can define the exit pupil 9; but, in this first embodiment of the present invention, it does constitute a substantially parallel beam. Due to this, if upon the optical path there is arranged an optical element which splits, deflects, condenses, or the like the luminous flux after it has been emitted, there is the beneficial aspect that it is possible to relax the demands for accuracy in arrangement of the direction of the optical axis, and that the arrangement and assembly become simplified.

For the surface shape of the transmission surface 7, there is employed a surface shape which is endowed with a positive power, in order to make the light which has been reflected by the splitting surface 6 into a substantially parallel beam, after imaging at the primary image plane 8. In order to compensate the decentering aberration, it is desirable to make the reflective surface 4 as a rotationally asymmetric surface.

As for the exit pupil 9, although it may be defined in any appropriate position, it is desirable for it to be disposed in the neighborhood of the transmission surface 7, in order to make the optical system as a whole more compact.

The operation of this prism 1 of this first embodiment of the present invention will now be explained by following along the optical path of its decentering optical system.

The luminous flux diameter of the incident luminous flux is constrained to the size of the entrance pupil diameter D by the aperture iris 2, and is incident upon the transmission surface 3.

Since the transmission surface 3 is disposed eccentrically or slantingly around the X axis with respect to the axial principal ray 50, the incident luminous flux 51 is curved and proceeds towards the outside of the incident optical axis.

And the luminous flux proceeds along within the medium and arrives at the reflective surface 4, and is internally reflected. Since the reflective surface 4 is endowed with a positive power, and is decentering around the X axis, along with the luminous flux being condensed, it proceeds towards the reflective surface 5 which is arranged next to the transmission surface 3, in the clockwise direction as seen in the figure (the positive direction around the X axis). Since the reflective surface 5 adjoins the transmission surface 3, the luminous flux which has passed through the transmission surface 3 is not affected by the reflective surface 5.

With this type of optical path, it is possible to obtain a satisfactory imaging performance by the angle of inclination |θ2−θ1| which specifies the inclination between the reflective surface 4 and the reflective surface 5 being set in the range which is specified by Equation (4) above.

The range specified by the above Equation (4) gives the range over which it is possible satisfactorily to compensate the coma aberration of the off-axis light beams as well, when the coma aberration which is generated due to the fact that the axial principal ray 50 is incident slantingly upon the reflective surface 4, which is a concave surface mirror, is compensated by endowing the reflective surface 4 with an asymmetric power. When this angle of inclination |θ2−θ1| becomes large and exceeds 80°, the asymmetry of the power of the reflective surface 4 becomes too large, so that it becomes difficult to compensate the coma aberration of the off-axis light beams.

Conversely, when the angle of inclination |θ2−θ1| becomes less than its lower limit value (in other words, when this angle of inclination |θ2−θ1| has become smaller than 30°), then the symmetry of the surfaces of the reflective surface 4 and the reflective surface 5 is remarkably deteriorated, and aberration of a degree which cannot be compensated is engendered, which is undesirable.

It is desirable for this range of the angle of inclination |θ2−θ1| to be kept within the range specified by the Equation (4) above, in order to minimize the aberration and to obtain a satisfactory imaging performance. And, for example, it is more desirable for the following Equation (4a) to be satisfied:
35°≦|θ2−θ1|≦70° (4a)

Furthermore, it is even more desirable for the following Equation (4b) to be satisfied:
40°≦θ2−θ1|≦60° (4b)

The luminous flux which has been reflected from the reflective surface 4 is internally reflected by the reflective surface 5, and, along with experiencing an optical effect according to the curvature of the reflective surface 5, proceeds towards the splitting surface 6, which is disposed neighboring to the transmission surface 3 in the anticlockwise direction as seen in the figure (the positive direction around the X axis). Since, in this luminous flux, its axial principal ray proceeds while crossing over with the axial principal ray of the luminous flux from the transmission surface 3 towards the reflective surface 4, accordingly, it is folded up into a three cornered shape within the prism 1. Moreover, since the splitting surface 6 adjoins the transmission surface 3, the luminous flux which has passed through the transmission surface 3 is not affected by the splitting surface 6.

If the reflective surface 5 is endowed with a negative power, then it is possible to perform satisfactory aberration compensation.

As shown in FIG. 2A, the luminous flux which has been internally reflected by the splitting surface 6, along with experiencing optical operation corresponding to the curvature of the splitting surface 6, proceeds towards the transmission surface 7 which is sandwiched between the reflective surface 5 and the reflective surface 4 while crossing over the axial principal ray of the luminous flux from the transmission surface 3 towards the reflective surface 4 and the axial principal ray of the luminous flux from the reflective surface 4 towards the reflective surface 5. In other words, it proceeds internally to the medium while being folded up into a three cornered shaped by the reflective surface 4, the reflective surface 5, and the splitting surface 6.

And, due to the powers of the first through the third surfaces and of the reflective aspect of the fourth surface, the primary image plane 8 is formed within the medium before arriving at the transmission surface 7.

Since, at this time, the ratio L/F between the air converted length L from the primary image plane 8 to the transmission surface 7 and the focal length F to the primary image plane 8 satisfies Equation (1) above, the distance from the primary image plane 8 to the transmission surface 7 is within the appropriate range, and it does not happen that the diameter of the luminous flux at the transmission surface 7 becomes too small, so that it is possible to form the exit pupil 9 comparatively closely to the emitting surface. As a result, it is possible to make the optical system more compact when arranging an optical element in the neighborhood of the exit pupil 9.

Furthermore, since the distance from the primary image plane 8 to the transmission surface 7 is within an appropriate range, accordingly it does not happen that the synthetic focal length of the reflection optical path becomes too short, so that it is possible to make the prism 1 more compact.

The luminous flux from the primary image plane 8 towards the exterior of the prism 1 proceeds towards the transmission surface 7 while its luminous flux diameter becomes progressively greater. And, after it has been made into a substantially parallel beam due to the positive power of the transmission surface 7, it is emitted to the exterior of the prism 1. And the exit pupil 9 is formed.

Accordingly, if an optical element is disposed in the neighborhood of the exit pupil 9, it is possible to make thin optical element more compact, since the entire luminous flux is transmitted in the range of the exit pupil 9, even if the angle of incidence of the incident luminous flux 51 varies. For example, by disposing a light deviation element such as a Galvano mirror, a light splitting element such as a beam splitter or the like, or a condensing lens or the like as such an optical element, it becomes possible to construct an optical system of high function which is very compact.

Furthermore, if a lens which is endowed with a positive power, such as the lens 10 for example, is arranged as a condensing element at the stage after the exit pupil 9, then it is possible to perform imaging of the luminous flux which has been emitted past the exit pupil 9 at the image surface 11. And, in correspondence to change of the angle of incidence of the incident luminous flux 51, it is possible to cause a real image to be formed at a predetermined position upon the image surface 11.

Yet further, by disposing at the image surface 11 an imaging element such as a light reception element like a PD (Photo Diode) or the like, a position detection sensor such as a PSD (Position Sensitive Detector) or the like, or an imaging element such as a CCD (Charge Coupled Device) or a CMOS (Complementary Metal Oxide Semiconductor) or the like, and so on, it becomes possible to obtain information concerning the incident luminous flux 51.

Upon the above described optical path, by setting the angle of inclination |θ4−θ3| which indicates the degree of parallelism between the splitting surface 6 and the transmission surface 7 within the range specified by Equation (5), so as to yield an inclination which is substantially parallel or shallow, it is possible to make the foreshortening of the image surface at the focal point surface small. As a result, along with obtaining a satisfactory imaging performance, it becomes possible to make this decentering optical system more compact.

In other words, when the angle of inclination |θ4−θ3| becomes large and exceeds 30°, the luminous flux from the splitting surface 6 towards the transmission surface 7 is greatly refracted by the transmission surface 7, and a large off-axis aberration is engendered, so that foreshortening of the image surface takes place. As a result, the imaging performance deteriorates, and in particular, if a light reception element or the like is disposed at the image surface 8, since it is necessary for such a light reception element to be arranged as inclined to the direction coming from the prism 1, it becomes impossible to make the device compact. However, if the condition specified by Equation (5) is satisfied, it is possible to avoid this problem.

In order further to reduce the aberration, and further to reduce foreshortening of the image surface, it is desirable to make the range of the angle of inclination |θ4−θ3| smaller than 30°, which is the upper limit value specified by the Equation (5) above. For example, it is more desirable for the Equation
|θ4−θ3|≦20° (5a)
to be satisfied.

Since, in this case, the optical path for imaging at the image surface 8 is reflected and folded up three times within the medium, which has a refractive index greater than 1, accordingly it is possible to manufacture a decentering optical system which is compact, even if the length of this optical path is long.

If, at this time, the paraxial focal length F to the primary image plane 8 of the decentering optical system due to the five optical surfaces is made to be within the range which is specified by Equation (2) above, then, since this paraxial focal length F is less than or equal to 500 mm, it is possible to restrict the size of the prism 1 itself to a size in a range in which a rotationally asymmetric surface of high accuracy can be properly processed. Furthermore, since this paraxial focal length F is greater than or equal to 60 mm, it is also possible to avoid the occurrence of the problem that the length of the optical path becomes too short, and that it is not possible sufficiently to manifest the beneficial effect which is obtained by folding up the optical path. As a result, along with manifesting the beneficial effect of folding up to a sufficient extent, it is also possible to manufacture a decentering optical system which can be made more compact, even though the length of the optical path is comparatively long.

Accordingly, by utilizing the present invention in an optical system in which the length of the optical path needs to be comparatively long, such as for example an optical system for a telescopic mirror or free space optical communication or the like, it is possible to anticipate an increase in compactness and lightness, and a reduction in cost.

Yet further, if it is arranged that the ratio F/D between the paraxial focal length F to the primary image plane 8 and the entrance pupil diameter D is within the range specified by the Equation (3) above, then, since this ratio F/D is less than or equal to 15, it is possible to manufacture a decentering optical system in which it does not happen that the length of the optical path becomes too long and the prism 1 becomes too much enlarged, or the back focus becomes too long. Furthermore, since the ratio F/D is greater than or equal to 2, accordingly it is also possible to manufacture a decentering optical system with which spherical aberration and coma aberration do not occur to an extent which cannot be compensated, because, as compared to the focal length, the diameter of the luminous flux is large and the NA (Numerical Aperture) is great. As a result, while maintaining a good balance as compared to the length of the optical path, it is possible to manufacture a prism 1 whose imaging performance is excellent.

Furthermore, since at least two among the five optical surfaces are made as rotationally asymmetric surfaces, it is possible to compensate the decentering aberration with high accuracy by combining these as asymmetric curved surfaces upon the side of the subsidiary light beams with respect to the axial principal ray 50. As a result, it is possible to manufacture a decentering optical system with low decentering aberration.

At this time, it would also be acceptable to make all of the five surfaces as rotationally asymmetric surfaces. If the number of rotationally asymmetric surfaces is thus increased, high accuracy aberration compensation becomes correspondingly possible. Furthermore, as a result of apportioning the compensation amount among optical surfaces, each of the curved surfaces becomes simple and easy to manufacture.

Moreover, if the required compensation of the decentering aberration is possible with two surfaces which are rotationally asymmetric, it will be acceptable to employ rotationally symmetrical surfaces or planes, which are easy to manufacture, for the remainder of the surfaces. In this case, it is possible to reduce the costs of manufacture. In particular, it is possible to reduce the costs of manufacture remarkably by employing planes for one or two of the surfaces.

Next, a first variant example of this first embodiment will be explained.

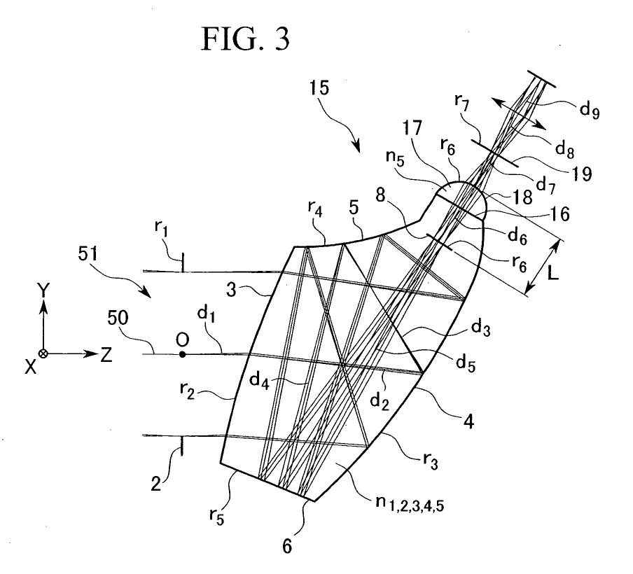

FIG. 3 is a figure for explanation of the first variant example of this first embodiment of the decentering optical system according to the present invention, and is an optical path diagram showing a cross section which includes the optical path of the axial principal ray. Moreover, the optical path shown in FIG. 3 indicates the above-mentioned reflection optical path; and each of the luminous fluxes is shown by the main light beam and the two subsidiary light beams for each case when the angle of incidence is 0° and ±0.4°.

The prism 15 of this variant example is one which has a joining surface 16 which consists of a plane instead of the transmission surface 7 of the prism 1 described above, and the planar side of a lens 17, which is a plano-convex lens, is joined against this joining surface 16. Accordingly, the facts that it has a splitting surface 6, that a reflection optical path and a transmission optical path are formed, and that a primary image plane 8 is defined within the medium of the prism 15, are the same as in the case of the first embodiment described above. In the following, the points in which this variant example differs from the first embodiment described above will be explained in a simple and concise manner.

At the convex surface 18 of the lens 17 (the fifth surface), after the luminous flux from the primary image plane 8 has been condensed and has been made into a substantially parallel beam, in the same manner as was the case for the transmission surface 7 of the first embodiment, this substantially parallel beam is emitted to the exterior of the lens 17, and also there is provided an optical surface which is endowed with a positive power, in order to define an exit pupil 19.

In this variant example as well, just as with the above described first embodiment, it is desirable for the Equations (1) through (3) to be satisfied.

Accordingly, if the mediums of the prism 15 and of the lens 17 of this variant embodiment are made to be the same material as the medium of the prism 1 of the first embodiment, by making the convex surface 18 and the transmission surface 7 of the same shape, it is possible to manufacture the same optical system with the prism 15 and the lens 17, as was the case with the prism 1.

Furthermore, by employing, as the material of the lens 17, a medium whose refractive index, while being greater than 1, is different from that of the medium of the prism 1, and by making the shape of the convex surface 18 to be one which is different from the shape of the transmission surface 17, it is also possible to vary the power of the convex surface 18, and thus to form the exit pupil 19 at a position which is different from that of the exit pupil 9 of the first embodiment.

According to the variant example explained above, by varying the shape of the lens 17, it is possible appropriately to vary the position of the exit pupil 19, and the spreading of the luminous flux after it has been emitted.

Moreover, for the joining at the joining surface 16, it is possible to utilize any appropriate methods, such as, for example, gluing with an adhesive for optical use, or the like. If, at this time, an appropriate coating is applied to the plane of the joining surface 16 and/or of the lens 17, then it is possible, for instance, to increase or decrease the transparency ratio at the joining surface 16, and to control the amount of light loss at the joining surface 16. Furthermore, it is possible to impart a filter characteristic or the like to the joining surface 16, and thereby to manufacture an optical system which is endowed with a sophisticated functionality.

Yet further, it would also be acceptable either to closely contact together the mutually opposing planes of the joining surface 16 and the lens 17, or, alternatively, to position these planes of the joining surface 16 and the lens 17 so as to provide an air gap between them. In this case, according to requirements, by exchanging the lens 17 with various different appropriate plano-convex lenses, it is possible to manufacture various different decentering optical systems with various different optical characteristics in a simple and easy manner.

### The Second Embodiment

The decentering optical system according to the second embodiment of the present invention will now be explained in the following.

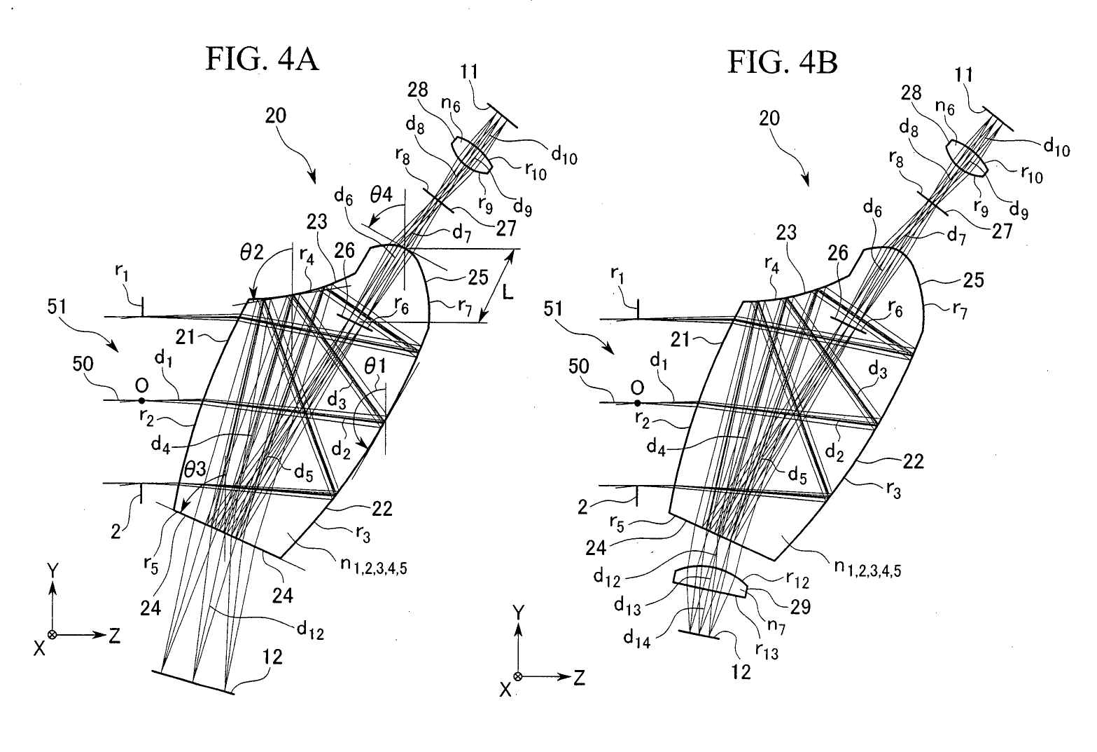

FIGS. 4A and 4B are figures for explanation of this second embodiment of the present invention and of a variant example thereof, and are optical path diagrams which include, in cross section, the optical path of an axial principal ray. In the same manner as in FIG. 1, in FIGS. 4A and 4B as well, the two optical paths are drawn as superimposed upon one another. In FIG. 4A there are drawn, as a main light beam and two subsidiary light beams, light beams whose angles of incidence (around an axis which is perpendicular to the drawing paper) are 0° and ±0.5°, and also light beams whose angles of incidence (around an axis which is perpendicular to the drawing paper) are 0° and ±1°. In FIG. 4B, there are drawn, as a main light beam and two subsidiary light beams, light beams whose angles of incidence (around an axis which is perpendicular to the drawing paper) are 0° and ±0.5°, and also light beams whose angles of incidence (around an axis which is perpendicular to the drawing paper) are 0° and ±1.6°.

An example of the decentering optical system according to this second embodiment of the present invention will now be explained.

In the decentering optical system according to this second embodiment a prism 20 is provided, instead of the prism 1 of the above described first embodiment, and a lens 28 (a light condensing device) is provided which images the substantially parallel beam which is emitted from the reflection optical path of this prism 20 at an imaging surface 11; so that this is an optical system in which, as before the incident luminous flux 51 is split between the reflection optical path and the transmission optical path, while on the other hand, in this second embodiment, these luminous fluxes are both imaged, respectively, at image surfaces 11 and 12 which are exterior to the prism 20. In the following, the aspects in which this second embodiment of the present invention differs from the first embodiment described above will be explained in a simple and easy manner.

As shown in FIG. 4A, the prism 20 includes, instead of the transmission surface 3, the reflective surface 4, the reflective surface 5, the splitting surface 6, and the transmission surface 7 of the prism 1 of the first embodiment, a transmission surface 21 (a first surface), a reflective surface 22 (a second surface), a reflective surface 23 (a third surface), a splitting surface 24 (a fourth surface), and a transmission surface 25 (a fifth surface). With this structure, corresponding to the primary image plane 8 of the prism 1 of the first embodiment, a primary image plane 26 is defined in the interior of the prism 20, and, corresponding to the exit pupil 9 of the prism 1 of the first embodiment, an exit pupil 27 which is exterior to the prism 20 is defined in the neighborhood of the transmission surface 25.

In other words, while the reference symbols are changed in correspondence with the preferred numerical value embodiments of the present invention which will be described hereinafter, the decentering optical system according to this second embodiment of the present invention is one which combines the prism 1 of the above described first embodiment and the lens 28, and which, when an incident luminous flux 51 is inputted, forms two real images at different positions which are exterior to the prism 1. Accordingly, since, with regard to the structure of each of the optical surfaces, and their operation and so on, everything is the same as in the case of the above described first embodiment, also including the point that it is desirable for the above described conditions (1) through (5) to be satisfied, the explanation thereof will herein be omitted.

Any type of optical element may be used for the lens 28, provided that it is one which forms a real image of the substantially parallel beam which is emitted from the exit pupil 27; and it is possible to employ any appropriate optical element which is endowed with a positive power such as, for example, a spherical lens, an aspheric surface lens, a Fresnel lens, a reflection mirror, a hologram element, or the like.

It should be understood that it is desirable for the lens 28, according to requirements, to be arranged eccentrically or slantingly with respect to the axial principal ray 50, after it has been emitted from the transmission surface 25. Furthermore, in order to perform the aberration compensation satisfactorily, it is desirable for it to include a rotationally asymmetric surface.

According to this type of structure, it is possible to image the incident luminous flux 51 at the image surface 12 after it has been subjected to satisfactory aberration compensation by the four optical surfaces upon the transmission optical path. Furthermore, upon the reflection optical path, it is possible to image the incident luminous flux 51 at the image surface 11 with the lens 28, after it has been subjected to satisfactory aberration compensation by the five optical surfaces, and furthermore, has been emitted to the exterior of the prism 20 in the neighborhood of the transmission surface 25 and the exit pupil 27 has been formed. Accordingly, if a light reception devices (for example, an imaging element such as a light reception element, a position detection sensor, a CCD, or the like) is arranged at each of these image surfaces 12 and 11, then it is possible to receive the light of the incident luminous flux 51 at the same time as two images of which the magnifications are different, and it is possible to obtain information according to individual light reception devices.

Yet further, for the same angle of incidence, it is possible to vary the shifting distance, the shifting speed, and so on of the images upon the image surfaces 12 and 11 individually when the angle of incidence of the incident luminous flux 51 changes, since it is possible to vary the paraxial focal lengths of the reflection optical path and of the transmission optical path independently by varying the power and the like of the various optical surfaces. Accordingly, by detecting the shifting distance and the shifting speed upon these image surfaces as information about the incident luminous flux, it is possible to detect the angle of incidence of luminous fluxes which have different detection sensitivity.

Next, a variant example of this second embodiment of the present invention will be explained.

As shown in FIG. 4B, in this variant example, between the splitting surface 24 upon the transmission optical path which has been explained in connection with the second embodiment described above, and the image surface 12, there is also provided a lens 29 (a light condensing device) which is endowed with a positive power or with a negative power.

For this lens 29, just as for the lens 28, it is possible to employ any optical element which is endowed with some optical power. Furthermore, it is desirable for this lens 29 to include a rotationally asymmetric surface which is arranged to be decentering or slanting with respect to the axial principal ray 50 which is emitted from the splitting surface 24.

In this case, according to requirements, it is possible to vary the position of the image surface 12, or the magnification of the image which is formed upon the image surface 12, without changing the shape of the splitting surface 24. Accordingly, it is possible to vary the magnification of each of the two real images in a simple and easy manner, and moreover independently of one another. Furthermore, it is possible to apply the prism 20 to a multiplicity of uses, and it is possible to use prisms 20 which have a common shape, even if they are to be used in various different optical systems.

Yet further, by apportioning the appropriate powers to the lenses 28 and 29, it becomes possible to make each of the optical surfaces of the prism 20 of a simple shape, so that it is thereby possible to decrease the manufacturing cost.

In this variant example, by employing a lens which is endowed with a positive power for the lens 29, it is possible to cause imaging to be performed upon a compact light receiving surface, even if the angle of view is large as compared to the FIG. 4A case. For example, as is shown in the third and fourth preferred numerical value embodiments to be described hereinafter, it is possible to achieve a remarkable degree of compactness of the device; for example, in FIG. 4B, for a half angle of view of 1.6°, it is possible to achieve an image height of the image surface of 2.4 mm, as compared to the case in FIG. 4A where, for a half angle of view of 10, the image height of the image surface is 4 mm.

### The Third Embodiment

The decentering optical system according to the third embodiment of the present invention will now be explained in the following.

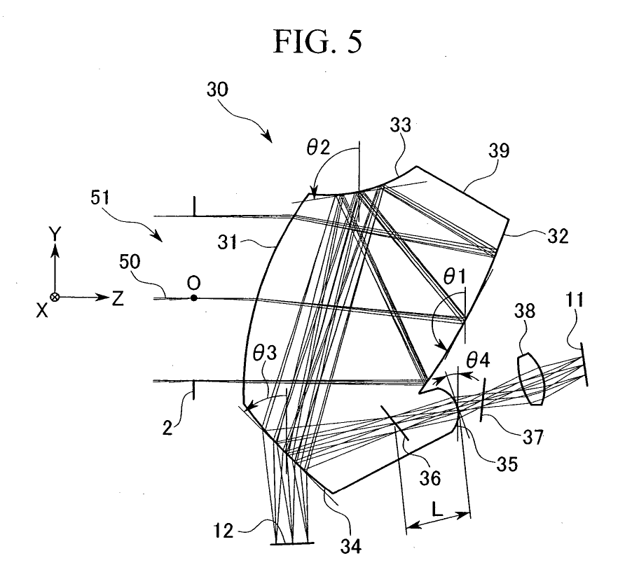

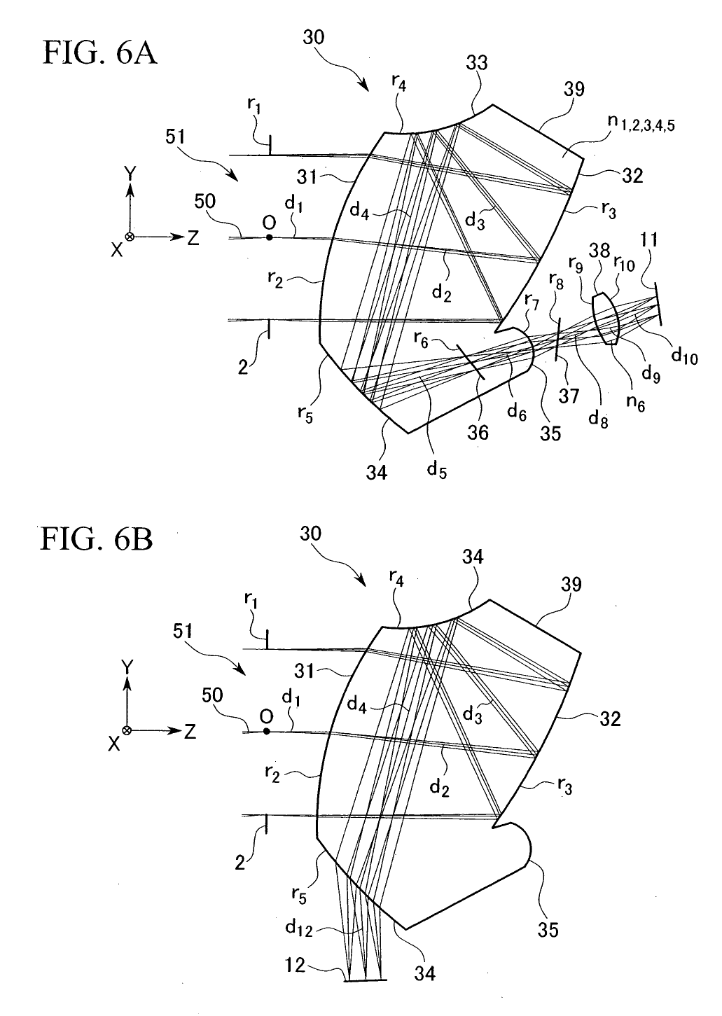

FIG. 5 is a figure for explanation of this third embodiment of the present invention, and is an optical path diagram which includes, in cross section, the optical path of an axial principal ray. In this figure, the two optical paths are drawn as being overlapped. FIGS. 6A and 6B are figures in which these optical paths are shown separately from one another. In FIG. 6A, there are drawn, as a main light beam and two subsidiary light beams, light beams whose angles of incidence (around an axis which is perpendicular to the drawing paper) are 0° and ±0.8°. In FIG. 6B there are drawn, as a main light beam and two subsidiary light beams, light beams whose angles of incidence (around an axis which is perpendicular to the drawing paper) are 0° and ±1°.

The decentering optical system according to this third embodiment of the present invention will now be explained.

As shown in FIG. 5, the decentering optical system of this third embodiment is one in which, instead of the prism 1 of the above described first embodiment, there is provided a prism 30, and a lens 38 (a light condensing device) is provided which images the substantially parallel beam which is emitted from a reflection optical path of the prism 30 upon an image surface 11, and in which the incident luminous flux 51 is split between the reflection optical path and a transmission optical path, which are respectively imaged upon image surfaces 11 and 12 which are exterior to the prism 30. In the following, the aspects in which this third embodiment of the present invention differs from the first embodiment described above will be explained in a simple and easy manner.

The prism 30 includes, instead of the transmission surface 3, the reflective surface 4, the reflective surface 5, the splitting surface 6, and the transmission surface 7 of the prism 1 of the first embodiment, a transmission surface 31 (a first surface), a reflective surface 32 (a second surface), a reflective surface 33 (a third surface), a splitting surface 34 (a fourth surface), and a transmission surface 35 (a fifth surface). With this structure, corresponding to the primary image plane 8 of the prism 1 of the first embodiment, a primary image plane 36 is defined in the interior of the prism 30, and, corresponding to the exit pupil 9 of the prism 1 of the first embodiment, an exit pupil 37 which is exterior to the prism 30 is defined in the neighborhood of the transmission surface 35.

The lens 38 is an element which may be of the same type as the lens 28 of the above described second embodiment.

The optical surfaces of the prism 30 in FIG. 5, as seen in the anticlockwise direction in the figure, are arranged in the order: the transmission surface 31, the splitting surface 34, the transmission surface 35, the reflective surface 32, and the reflective surface 33. And, in the arrangement from the first surface through the third surface, just as was the case with the prisms 1 and 20 of the first and second embodiments described above, the angles of inclination of the second surface and the third surface satisfy the condition specified by the Equation (4) above.

On the other hand, the aspect in which this prism 30 differs from the prisms 1 and 20 of the first and second embodiments described above, is that the fifth surface is positioned between the third surface and the second surface. Accordingly, the axial principal ray 50 upon the optical path which is reflected from the fourth surface towards the fifth surface does not cross over either of the axial principal ray 50 from the first surface towards the second surface or the axial principal ray 50 from the second surface towards the third surface.

Due to this, while the beneficial aspect of it being possible to make the device more compact by making the optical paths within the prism 30 cross over one another is relatively less prominent than was the case for the first and the second embodiments, on the other hand, it is possible for the emitted luminous flux on the side of the reflection optical path to be emitted along the general direction of progression of the incident luminous flux 51, i.e., so that their directions are substantially parallel, or so that they intersect one another at a comparatively shallow angle. As a result, it is possible to set this optical system in place, even in a case in which the available space in the directions which intersect the direction of the incident luminous flux 51 is very limited.

### The Fourth Embodiment

An acquisition and tracking device according to the fourth embodiment of the present invention will now be explained. This optical acquisition and tracking device according to the fourth embodiment includes an optical receiving device section and an optical transmitting device section.

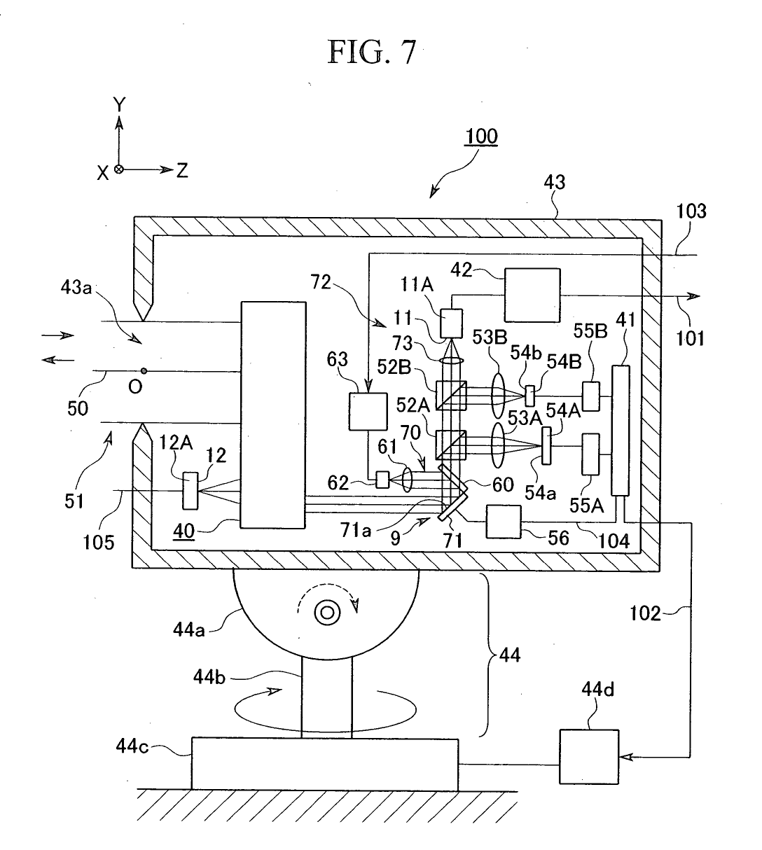

FIG. 7 is a schematic cross sectional view for explanation of the general structure of this optical acquisition and tracking device according to the fourth embodiment of the present invention.

An optical tracking device 100 (optical acquisition and tracking device) according to the fourth embodiment of the present invention will now be explained. This optical tracking device 100 is a device which transmits and receives substantially parallel input light such that the substantially parallel input light can be tracked. In particular, the optical tracking device 100 is a device which can very appropriately be utilized in the field of free space optical communications.

First, an optical receiving device section of the optical tracking device 100 will be explained.

The optical receiving device section of the optical tracking device 100 includes, generally, a chassis 43 (a device external casing), a decentering optical system 40, a movable reflection element 71 (a light deviation device), a light reception section 72, a deviation control device 56, a control device 41, an input signal controller 42, and a gimbal stage 44 (a tracking shift mechanism).

The chassis 43 is a member which serves both as a holding member which holds together the various members which will be subsequently described, and as an external casing member, and it is made in an appropriate shape, such as for example a box shape or the like. At a portion of the outer surface of this chassis 43, there is provided an aperture iris 43a, which is an aperture section which constitutes an entrance pupil for an incident luminous flux 51. This aperture iris 43a is provided as an effective iris which, in the normal state of use, initially regulates the luminous flux diameter of the incident luminous flux 51 when the incident luminous flux 51 has irradiated into the chassis 43, and it is a member which implements the aperture iris 2 of the decentering optical system of the first through third embodiments of the present invention described above.

The aperture iris 43a may be formed as a separate member from the chassis 43, or, more precisely, it need not necessarily be provided upon the outer surface of the chassis 43. For example, provided that it is of a shape for which, in the state of normal use, there is no danger that it will block the incident luminous flux 51, a hood or the like for preventing the incidence of flare light may be provided around the aperture iris 43a.

For this aperture iris 43a anything will serve, provided that it is optically open; for example, it will be acceptable to cover it over with a cover glass or the like which is transparent to light for condensation of the required wavelength.

For the decentering optical system 40, any one of the prisms 1, 15, 20, 30, and so on which is used in the decentering optical system according to any one of the above described first through third embodiments of the present invention shown in FIG. 1 and so on may be utilized. In this case, this prism is fixed to the chassis 43 via an appropriate support member not shown in the figure, so that the aperture iris 43a comes to be positioned in the position of the aperture iris 2 described above.

A light reception element 12A is disposed at the image surface 12 of the transmission optical path of the decentering optical system 40, in order to observe the image of the incident luminous flux 51 and obtain information. The signal which is detected by the light reception element 12A is dispatched as a detection signal 105.

The movable reflection element 71 is an optical element which has a reflective surface 71a of a planar surface shape, and which can be rotationally moved around two axes; for example, there may be employed a Galvano mirror or an optical MEMS (Micro Elector Mechanical System) which is driven by an appropriate rotational driver such as, for example, an actuator or the like. This movable reflection element 71 is arranged in a position in which its reflective surface 71a is roughly overlapped with the exit pupil 9 of the decentering optical system 40.

The light reception section 72 is an optical system which reflects the luminous flux which is emitted from the reflection optical path of the decentering optical system 40 with the movable reflection element 71 and splits it into a plurality of optical paths, and which furthermore condenses it upon a plurality of light reception surfaces. In other words, a lens 73, which is the same condensing lens as the lenses 28 and 38 of the second and third embodiments described previously, is positioned upon the optical path in a neutral position with respect to the movable reflection element 71, and a light reception element 11A is positioned at the image surface 11 of its image side, so as to define a single light reception surface. And, between the movable reflection element 71 and the lens 73, there are disposed beam splitters 52A and 52B (optical path splitting device) from the body side, and, along with respective condensing lenses 53A and 53B (light condensing device) being disposed upon the optical paths which have been split by each of these beam splitters 52, light reception elements 54A and 54B are provided on their image sides. And the luminous fluxes which have been split are received upon the light reception surface 54a of the light reception element 54A and upon the light reception surface 54b of the light reception element 54B.

As has been explained above, the decentering optical system which has been explained above in connection with the second and third embodiments of the present invention described above is included in the optical receiving device section of the optical tracking device 100.

Each of the beam splitters 52A and 52B is an optical element which splits the optical path of the substantially parallel beam which has been reflected by the movable reflection element 71. As for each of these beam splitters 52A and 52B, for example, there may be employed any type of optical element or the like which splits the optical path according to some wavelength characteristic, such as a beam splitter prism upon which a half mirror coating has been applied, a half mirror, or a polarized light beam splitter (PBS) which splits the optical path according to a light polarization characteristic.

The condensing lens 53A (53B) is an optical element for condensing the substantially parallel beam which has been split by the beam splitter 52A (52B) onto the light reception surface 54a (54b) of the light reception element 54A (54B).

The light reception elements 54A and 54B are elements for detecting the amount of deviation of the direction of incidence of the incident luminous flux 51, and, for them, there may be employed position detection sensors which are capable of detecting an imaging position, such as, for example, CCDs or PSDs or 4-division PDs or the like. These light reception elements 54A and 54B have mutually different position detection sensitivities. Here, the explanation will be made in terms of the light reception element 54A performing position detection over a wider range, than does the light reception element 54B. For example, it is possible to employ a structure in which the shift amount of the luminous flux upon the light reception surface 54a, when the angle of incidence has varied due to change of the focal length of the condensing lenses 53A and 53B or of the position at which they are arranged, is smaller than the corresponding shift amount upon the light reception surface 54b.

Direction of incidence detection devices 55A and 55B, which perform signal processing or the like upon these detected signals and which calculate imaging position information or the amount of positional deviation of the luminous flux, are connected to the light reception elements 54A and 54B. These direction of incidence detection devices 55A and 55B are able to convert the results of their calculations into a direction of incidence of the incident luminous flux 51, and to output control signals (position signals) for controlling the position of the chassis 43, so as to set it to the appropriate direction of incidence.

The direction of incidence detection device 55B whose sensitivity with respect to the amount of deviation of the direction of incidence is the higher inputs a control signal 104 based upon the amount which it has detected, via the control device 41, to a deflection controller 56 for controlling the angle of deflection of the movable reflection element 71. And the deflection controller 56 is controlled by this control signal 104.

The control device 41 is a device which generates a control signal 102 for appropriately shifting the direction of the chassis 43, based upon the control signals which are outputted from the direction of incidence detection devices 55A and 55B.

The input signal controller 42 is a device which performs appropriate signal processing upon an electrical signal which has been photoelectrically converted from the image upon the image surface 11, and which dispatches an input signal 101 to the exterior of the device. In particular, since this device is used as a light reception section in space optical signal transmission, it is desirable to provide a modulated light detection device which extracts the modulated light which is included in the information signal from the received light luminous flux.

The gimbal stage 44 is a shift mechanism which holds the chassis 43 while being able to control its attitude around two axial directions, and it includes: a vertical rotational drive section 44a and a horizontal rotational drive section 44b supported upon a support plinth 44c; and a drive controller 44d for controlling the shift amounts of the vertical rotational drive section 44a and the horizontal rotational drive section 44b.

These horizontal rotational drive section 44b and vertical rotational drive section 44a can perform rotation around the horizontal axis with a predetermined angle and rotation around the vertical axis, and can be driven by a mechanism such as a control motor (not shown in the figures) or the like which is for controlling the rotational angles.

A drive controller 44d is a device which, based upon the control signals which are generated by the control device 41, calculates rotational drive amounts for the vertical rotational drive section 44a and the horizontal rotational drive section 44b, and performs predetermined rotational driving thereof.

According to this optical receiving device section of the optical tracking device 100 of this fourth embodiment of the present invention, if the direction of incidence of the incident luminous flux 51 is within an appropriate range, this incident luminous flux 51 is incident upon the aperture iris 43a. The incident luminous flux 51 has a luminous flux diameter which is large as compared with the diameter of the aperture iris 43a, and, in the normal range of use, even if the angle of incidence varies, the aperture iris 43a remains within the cross section of the incident light beam 51. The incident luminous flux 51 which is incident upon the aperture iris 43a enters into the reflection optical path within the decentering optical system 40, and is imaged at the image surface 11. And the detected output of the light reception element 11A is dispatched to the input signal controller 42, and the input signal 101 is dispatched to the exterior of the device. Here, in the initial state, the angle of deflection of the movable reflection element 71 is fixed to its neutral position in which the axial principal ray arrives at the center of the image surface 11.

Furthermore, the substantially parallel beams which have been split by the beam splitters 52A and 52B are condensed by the condensing lenses 53A and 53B, and arrive at the light reception elements 54A and 54B. And detection outputs according to the positions of the light which is received are dispatched to the direction of incidence detection devices 55A and 55B.

On the other hand, if the optical path of the incident luminous flux 51 changes, or the position of the chassis 43 becomes inappropriate, in other words if the incoming incident light beam 51 has an angle of incidence with respect to the aperture iris 43a, then the positions upon the two light reception surfaces are displaced.

In this case, the direction of incidence detection device 55B calculates an amount of rotational movement (a deflection amount) for the movable reflection element 71, based upon the relationship between the direction of incidence of the incident luminous flux 51, which is determined from the optical characteristics of the decentering optical system 40, and the position of light reception upon the light reception surface 54b, and sends it as a control signal 104 to the control device 41 and the deflection controller 56. And the movable reflection element 71 is controlled, and performs tracking. At this time, the shift amounts of the gimbal stage 44 are controlled by the control device 41 so as always to keep the angle of incidence within the range which can be detected by the direction of incidence detection device 55B.

The direction of incidence detection device 55A calculates a shift amount for the chassis 43, based upon the relationship between the direction of incidence of the incident luminous flux 51, which is determined from the optical characteristics of the decentering optical system 40, and the position of light reception upon the light reception surface 54a, and sends a control signal 102 to the drive controller 44d and the control device 41. And the movable reflection element 71 is controlled, and performs tracking. If the direction of incidence detection device 55A detects that the incidence is out of the predetermined region of its detection range, then it notifies the control device 41 to this effect. This direction of incidence detection device 55A has a wide detection range, so that, by controlling the gimbal stage 44 by receiving the signal from the direction of incidence detection device 55A, it is always possible to perform position detection.

When the control device 41 receives control signals from the direction of incidence detection devices 55A and 55B, the control device 41 sends the control signal 102 to the drive controller 44d. The control signal 102 is a signal for determining the shift target position of the chassis 43. This shift target position is determined so as to make the optical axis of the incident luminous flux 51 and the incident optical axis of the decentering optical system 40 agree with one another, within a predetermined range.

In this case, if it is possible for the gimbal stage 44 to shift with high accuracy, it will be acceptable to arrange to control the shift amount based upon the higher resolving power position information from the direction of incidence detection device 55B; but, for performing high speed shifting, it is also possible to generate the control signal 102 based upon the wider range position information from the direction of incidence detection device 55A, so as to cause shifting to an approximate target position. This approximate target position is made to be a target value which is at least of an accuracy which is sufficient for a detection output to be generated by the light reception element 54B.

When shifting to the approximate target value has been performed, the gimbal stage 44 is held in the stopped position. And, based upon the control signal which is sent from the control device 41 to the deflection controller 56, the movable reflection element 71 is rotationally moved, and angle of deflection control is performed so that the position of light reception upon the image surface 11 becomes a constant position. However, if the angle of incidence of the incident light continues to vary continually, control is performed by the gimbal stage 44 and the movable reflection element 71 in cooperation, so as always to maintain the most appropriate light reception state.

For example, in the field of optical communication, along with the tendency to increase of the already high speed of communication, the light receiving area of the light reception element 11A and so on has become smaller. In particular, if the light reception area of the light reception element 11A is the end surface of an optical fiber, then, for such a light reception surface which has been made to be of extremely small diameter, such as in the case of, for example, a core diameter of 10 μm or less, there is a demand to combine the luminous flux into a small spot diameter.

If this type of fine motion control were to be performed only by the gimbal stage 44, then there would be a requirement for extremely high accuracy. Thus, in this case, it is desirable to perform tracking at high accuracy with the movable reflection element 71 (the Galvano mirror).

Next, an optical transmitting device section of this optical acquisition and tracking device according to this fourth embodiment of the present invention will be explained.

This optical transmitting device section of the optical tracking device 100 includes a light source section 70, an output signal controller 63, and a half mirror 60 (an optical path synthesis device), and is endowed with the function of transmitting light.

The light source section 70 includes a semiconductor laser 62 and a collimator lens 61 for ensuring that the luminous flux which emanates from this semiconductor laser 62 consists of parallel output light.

The output signal controller 63 is a device which controls the semiconductor laser 62, based upon an output signal 103 which is to be conveyed by the luminous flux which is to be dispatched.

The half mirror 60 is disposed upon the optical path between the movable reflection element 71 and the beam splitter 52A, and is an optical element which, along with being substantially transparent to a luminous flux which is incident from a body upon the optical path, also reflects the output light which is emitted from the light source section 70 along the optical axis towards the body. For this half mirror 60, for example, it is possible to employ the same type of optical element as is appropriately used for the beam splitter 52A.

The optical transmitting device section of the optical tracking device 100 adjusts the position of arrangement from the light source section 70 with respect to the half mirror 60, and causes the output light which is emitted from the light source section 70 to be incident so that its optical axis coincides with the axial principal ray between the movable reflection element 71 and the beam splitter 52A. As a result, the output light is incident upon the exit pupil 9 and the decentering optical system 40 in the neighborhood of the movable reflection element 71, and proceeds along the reflection optical path of the decentering optical system 40 in reverse, and is emitted to the exterior of the chassis 43 from the aperture iris 43a, which is its entrance pupil.

Since, at this time, the angle of deflection of the movable reflection element 71 is controlled so as to cause the incident luminous flux 51 to be imaged at the predetermined position upon the image surface 11, therefore the axial principal ray within the path comes to be fixed. Accordingly, the position of the light source section 70 is not varied in order to control the direction of emission of the output light, but rather, while this is kept fixed just as it is, it is always possible to cause the output light to be emitted towards an accurate direction. In other words, this device is endowed with the light transmission function of causing the output light to be emitted towards the exterior of the device in reverse along the optical path which is pursued by the input light.

Since, as has been explained above, the optical receiving device section of the optical tracking device 100 is an optical receiving device which is capable of optical acquisition and tracking even if the angle of incidence of the incoming light varies, accordingly it is possible to perform light reception in a stabilized manner with very little variation in the amount of light which is received. Furthermore, since the approximate rough shifting is performed by the gimbal stage 44, and, for the fine motion control for which higher speed control is required, the angle of deflection of the luminous flux is controlled by the movable reflection element 71, accordingly it is possible to manufacture an optical acquisition and tracking device which is extremely suitable in the case of a requirement for high accuracy and high speed responsiveness, such as is needed for free space optical communications.

Furthermore, since this optical transmitting device section of the optical tracking device 100 is able to make dual use of the main portion of the decentering optical system 40 when transmitting light, accordingly, along with it being possible to manufacture this device with a small number of components, it is also possible to manufacture this device to be compact. Yet further, since it is possible to employ only the input light in the optical acquisition and tracking process, while emitting the output light accurately, accordingly it is possible to manufacture this device to be of a simple structure, and thus it is possible to manufacture a device at a cheap price.

According to the optical tracking device 100 of this fourth embodiment of the present invention as explained above, along with reaping the beneficial effects of the decentering optical systems of the above described first through third embodiments of the present invention, it is also possible to manufacture an optical acquisition and tracking device which can perform stabilized optical transmission and reception, while performing optical acquisition and tracking of the input light with high accuracy and moreover at high efficiency.

Moreover, it is possible to produce an optical system for free space optical communication which performs transmission and receipt of light, in both directions, and which is stabilized by tracking, by arranging two of these optical acquisition and tracking devices confronting one another and mutually spaced apart, since each of them has its own optical transmitting device section and its own optical receiving device section, and since moreover both of them are capable of optical acquisition and tracking, even if their relative position changes.

Furthermore, in this case, by omitting portions other than the decentering optical system of the optical receiving device section of one of these optical acquisition and tracking devices, it becomes possible to configure an optical transmitting device which is equipped with the output signal controller, the light source section which emits a substantially parallel beam, and the decentering optical system. Yet further, by omitting the portions of the optical transmitting device section, other than the decentering optical system, from the other one of the optical acquisition and tracking devices which is positioned at a position confronting the first one thereof and mutually spaced apart therefrom, it is possible to produce an optical receiving device which can perform optical acquisition and tracking, and which is equipped with, for example, the decentering optical system 40, the movable reflection element 71, the light condensing device 53A and 53B, the light reception elements 54A and 54B, the direction of incidence detection devices 55A and 55B, the control device 41, and the deflection controller 56. By doing this, it is possible to produce a uni-directional optical system for free space optical communication which can perform optical acquisition and tracking.

Even further, for a beacon light which transmits light upon which no signal modulation has been performed by any output signal controller of the optical transmitting device, if the light reception element 11A and/or the input signal controller 42 of the optical receiving device is omitted, then it is also possible to make an optical system for optical acquisition and tracking which is not limited to free space optical communication.

Furthermore, with a bi-directional or uni-directional optical system for free space optical communication, if an optical system which is separate from the decentering optical system and which has been aligned to the optical axis of the decentering optical system is provided on each of the light transmission side and the light reception side, then it is possible to build an optical system for free space optical communication in which the optical system for tracking and light transmission and reception is a separate unit.

Yet further, it is also possible for only the optical transmitting device section of the beacon light to be made as an optical system which is separate from the decentering optical system, and to be aligned to the optical axis of the decentering optical system.

Still further, if there is no possibility of change of relative position such as between two buildings or the like, then, by omitting the sections which are related to tracking from the optical receiving device (portion), it is possible to manufacture a bi-directional or unidirectional optical device for free space optical communication which is equipped with a fixed decentering optical system.

It should be understood that, with any of the above described embodiments of the present invention, it is possible to utilize an appropriate combination of the conditions specified by Equations (1) through (5) and Equations (1a) through (5a) and (1b) through (4b).

Moreover, it should be understood that, in the above described first through third embodiments, the explanation was made to the decentering optical system in which the fourth surface was used as the splitting surface by way of example. By contrast, if it was not necessary to have two different optical paths, or if a plurality of optical paths were formed by splitting the optical path after it had been emitted from the fourth surface or from the fifth surface, then it would also be acceptable for the fourth surface not to be utilized as a splitting surface. However, if in fact the fourth surface is used as a splitting surface, then it would also be acceptable to utilize only one or the other of the reflected light beam and the transmitted light beam.

Even further, it would also be acceptable to make the fourth surface as a reflective surface, and only to take advantage of the luminous flux which has been emitted from the fifth surface, or to make the fourth surface as a transmission surface, and only to take advantage of the luminous flux which has been emitted from the fourth surface. In such a case, it would be possible to employ a reflective coating of low transmission ratio, or a low reflection coating (an AR coating), as a coating for the fourth surface.

Yet further although, in the above described first through third embodiments of the present invention, the explanation was made, by way of example, in terms of a reflective coating or a half mirror coating which can control the reflection ratio for internally incident light being applied to the fourth surface, it would also be acceptable to employ a different coating for making the fourth surface into a splitting surface.

For example, it would be acceptable to perform polarized beam splitter coating (PBS coating), so as to perform splitting according to the polarization state of the luminous flux which arrives at the fourth surface. By changing the PBS coating according to the state of polarization before the input light arrives at the fourth surface, it is possible to adjust the optical splitting ratio. Furthermore, according to requirements, it would also be acceptable to provide, in an appropriate position, an optical element which alters the state of polarization, such as an appropriate light polarization element or the like.

For example, it would be acceptable to apply a dichroic beam splitter coating to the fourth surface, and to perform splitting according to the wavelength of the luminous flux which arrives at this fourth surface.

Although, in the above described first through third embodiments of the present invention, the explanation was made, by way of example, in terms of two image surfaces being defined exterior to the prism, it would also be acceptable to provide a splitting surface upon the optical path exterior to the prism, and thereby to arrange to split the luminous flux into a plurality of optical paths, and to define a plurality of image surfaces. Since, in such a case, it would be possible to arrange a light reception element or a position detection device at each of the image surfaces, accordingly, by using their outputs, it would be possible to perform position detection at even higher accuracy.

Although, in the above description of the third embodiment of the present invention, by way of example, the case was explained in which the control device 41, the input signal control device 42, and the deflection controller 56 were housed within the chassis 43, it goes without saying that it would also be acceptable to arrange them separately from the chassis 43.

And although, in the above description of the fourth embodiment of the present invention, by way of example, the case was explained in which an optical path synthesis device was provided between the reflective surface which was capable of being rotationally moved and the first optical path splitting device, it would also be acceptable for it to be positioned in any appropriate position, provided that it was towards the image side of the exit pupil. For example, it would be acceptable to be between the optical path splitting device themselves, or on the image side thereof. Yet further, it would also be acceptable for it to be on the image side of the light condensing device. In this case, in the light source section, it would be acceptable to utilize the optical element of the light condensing device also as an optical element for improving the parallelism of the luminous flux.

Although, in the above description of the fourth embodiment of the present invention, by way of example, the case was explained in which the decentering optical system was housed within the device external casing, and the entire device external casing was shifted by the tracking shift mechanism, alternatively, it would also be acceptable for only the decentering optical system to perform tracking shifting. In such a case, it would be acceptable for the aperture iris 43a not to be provided upon the device external casing, but, rather, for an optical unit to be provided which held the decentering optical system in the interior of its device external casing, and for it to be arranged to shift this optical unit with the tracking shift mechanism. Moreover, in this case, it would be possible to provide the elements of the decentering optical system, other than the direction of incidence detection device, the rotational drive controller and so on, outside the optical unit. As a result, it would be possible to perform optical acquisition and tracking operation at higher speed, since the inertia during operation of the tracking and shift mechanism would be reduced.

Still further, although, in the above description of the fourth embodiment of the present invention, by way of example, the case was explained in which the luminous flux upon the side of the reflection optical path was received and was inputted to the input signal control device 42 and to the control device 41, according to requirements, it would also be acceptable to arrange to input the detection signal 105 of the light reception element 12A.

### The First Preferred Numerical Value Embodiment

Next, a first preferred numerical value embodiment of the decentering optical system according to the first embodiment of the present invention described above will be explained with reference to FIGS. 2A and 2B.

In the following, the structural parameters of an optical system according to this first preferred numerical embodiment are specified. The rᵢ and dᵢ (where i is an integer) shown in FIGS. 2A and 2B correspond to the structural parameters rᵢ and dᵢ of the optical system described below. The refractive indexes given for d-rays (of wavelength 587.56 nm) are shown. These specifications are common to all of the reference figures below.

The optical path 1 is the optical path along which the luminous flux which is reflected from the splitting surface 6 proceeds (refer to FIG. 2A), and the optical path 2 is the optical path along which the luminous flux which is transmitted through the splitting surface 6 proceeds (refer to FIG. 2B).

It should be understood that, among the data for the freely curved surfaces (FFS) and for the decentering surfaces, to those items which are common for the optical paths 1 and 2, common numbers within brackets [ ]are appended, and duplication is avoided.

Since the coordinate system and so on has already been explained, further discussion thereof is omitted. The symbols α, β, and γ which specify the eccentricity denote the angles of the directions which have been explained in the above description as being the directions of the angles of inclination. The units of length are (mm), and the units of angle are (°). The origin and the rotational center of the eccentricity are appropriately annotated in the data.

The freely curved surfaces are given by the Equation (a) which has been explained in the above description. It should be understood that items related to the freely curved surfaces or the aspheric surfaces for which no data is given have the value zero.

(optical path 1)

| Surface | | | | | |
|---|---|---|---|---|---|
| Number | Curvature | Surface | | | |
| Body | Radius | Gap | | Refractive | Abbe |
| Surface | ∞ | ∞ | Eccentricity | Index | Number |
| 1 | ∞ (iris | d₁ = 2.00 | | | |
| | surface) | | | | |
| 2 | FFS[1] | d₂ = 0.00 | eccentricity [1] | n₁ = 1.5254 | ν₁ = 56.2 |
| 3 | FFS[2] | d₃ = 0.00 | eccentricity [2] | n₂ = 1.5254 | ν₂ = 56.2 |
| 4 | FFS[3] | d₄ = 0.00 | eccentricity [3] | n₃ = 1.5254 | ν₃ = 56.2 |
| 5 | FFS[4] | d₅ = 0.00 | eccentricity [4] | n₄ = 1.5254 | ν₄ = 56.2 |
| 6 | ∞ (primary | d₆ = 0.00 | eccentricity [5] | n₅ = 1.5254 | ν₅ = 56.2 |
| | image plane) | | | | |
| 7 | FFS[5] | d₇ = 0.00 | eccentricity [6] | | |
| 8 | ∞ (exit pupil) | d₈ = 10.00 | eccentricity [7] | | |
| 9 | ∞ (ideal lens) | d₉ = 10.00 | | | |
| image | ∞ | d₁₀ = 0.00 | | | |
| plane | | | | | |

| | |
|---|---|
| FFS[1]: | C₄ = 1.1916 × 10⁻², C₆ = 1.9672 × 10⁻³, C₈ = 5.8335 × 10⁻⁵, |
| | C₁₀ = 9.3853 × 10⁻⁶, C₁₁ = 8.3918 × 10⁻⁷, C₁₃ = −7.9209 × 10⁻⁷, |
| | C₁₅ = 6.9622 × 10⁻⁷, C₁₇ = 1.9564 × 10⁻⁸, C₁₉ = 1.6950 × 10⁻⁸, |
| | C₂₁ = −5.4054 × 10⁻⁹ |
| FFS[2]: | C₄ = 8.4125 × 10⁻⁴, C₆ = −3.1221 × 10⁻³, C₈ 2.6985 × 10⁻⁵, |
| | C₁₀ = −1.9713 × 10⁻⁵, C₁₁ = −5.3738 × 10⁻⁷, C₁₃ = −3.5866 × 10⁻⁷, |
| | C₁₅ = −6.0551 × 10⁻⁹, C₁₇ = −2.1823 × 10⁻⁸, C₁₉ 1.8897 × 10⁻⁹, |
| | C₂₁ −1.1519 × 10⁻⁹ |
| FFS[3]: | C₄ = −2.3965 × 10⁻³, C₆ = −6.8603 × 10⁻³, |
| | C₈ = 3.6261 × 10⁻⁶, C₁₀ = −7.4904 × 10⁻⁵, C₁₁ = −2.9687 × 10⁻⁶, |
| | C₁₃ = −3.0602 × 10⁻⁶, C₁₅ = 1.0182 × 10⁻⁶, C₁₇−1.2686 × 10⁻⁷, |
| | C₁₉ = −1.9603 × 10⁻⁸, C₂₁ = 5.7999 × 10⁻⁹ |
| FFS[4]: | C₄ = −7.2261 × 10⁻⁴, C₆ = −8.3825 × 10⁻⁴, C₈ = 7.9289 × 10⁻⁶, |
| | C₁₀ = 6.6475 × 10⁻⁶, C₁₁ = −5.0317 × 10⁻⁷, C₁₃ = −6.4622 × 10⁻⁷, |
| | C₁₅ = −3.0789 × 10⁻⁷, C₁₇ = −6.6292 × 10⁻⁸, C₁₉ = −1.2786 × 10⁻⁸, |
| | C₂₁ = −1.7236 × 10⁻⁸ |
| FFS[5]: | C₄ = 9.7263 × 10⁻², C₆ = 9.7160 × 10⁻², C₈ = −2.9297 × 10⁻⁴, |
| | C₁₀ = −2.4558 × 10⁻⁴, C₁₁ = 1.8329 × 10⁻⁴, C₁₃ = 2.0941 × 10⁻⁴, |

| | | | |
|---|---|---|---|
| eccentricity [1]: | X = 0.00 | Y = 0.00 | Z = 13.94 |
| | α = −17.73 | β = 0.00 | γ = 0.00 |
| eccentricity [2]: | X = 0.00 | Y = −4.44 | Z = 55.08 |
| | α = −32.64 | β = 0.00 | γ = 0.00 |
| eccentricity [3]: | X = 0.00 | Y = 27.18 | Z = 36.16 |
| | α = −81.34 | β = 0.00 | γ = 0.00 |
| eccentricity [4]: | X = 0.00 | Y = −32.53 | Z = 21.74 |
| | α = −112.60 | β = 0.00 | γ = 0.00 |
| eccentricity [5]: | X = 0.00 | Y = 28.02 | Z = 59.03 |
| | α = 69.57 | β = 0.00 | γ = 0.00 |
| eccentricity [6]: | X = 0.00 | Y = 40.91 | Z = 66.97 |
| | α = −124.22 | β = 0.00 | γ = 0.00 |
| eccentricity [7]: | X = 0.00 | Y = 50.02 | Z = 72.29 |
| | α = 59.71 | β = 0.00 | γ = 0.00 |

(optical path 2)

| Surface | | | | | |
|---|---|---|---|---|---|
| Number | Curvature | Surface | | | |
| Body | Radius | Gap | | Refractive | Abbe |
| Surface | ∞ | ∞ | Eccentricity | Index | Number |
| 1 | ∞ (iris | d₁ = 2.00 | | | |
| | surface) | | | | |
| 2 | FFS[1] | d₂ = 0.00 | eccentricity [1] | n₁ = 1.5254 | ν₁ = 56.2 |
| 3 | FFS[2] | d₃ = 0.00 | eccentricity [2] | n₂ = 1.5254 | ν₂ = 56.2 |
| 4 | FFS[3] | d₄ = 0.00 | eccentricity [3] | n₃ = 1.5254 | ν₃ = 56.2 |
| 5 | FFS[4] | d₅ = 0.00 | eccentricity [4] | n₄ = 1.5254 | ν₄ = 56.2 |
| image | ∞ | d₁₁ = 0.00 | eccentricity [8] | | |
| plane | | | | | |

| | | | |
|---|---|---|---|
| eccentricity [8]: | X = 0.00 | Y = −88.32 | Z = 13.08 |
| | α = 79.29 | β = 0.00 | γ = 0.00 |

Among the characteristic optical values of the decentering optical system of this first preferred numerical value embodiment, the entrance pupil diameter D, the half angles of view φ_{X} and φ_{Y}, the image heights of the image surface (the half angles) H_{X} and H_{Y}, the paraxial focal lengths to the primary image plane F_{X} and F_{Y}, the air converted length L from the primary image plane to the fifth surface, and the various calculated values for Equation (1) through Equation (5) are shown in the following Table 1, along with the values for the embodiments:

Here, the subscripts X and Y denote distances and rotational angles related to the X and the Y axis direction respectively; and the same is the case in the other preferred numerical value embodiments described below.

TABLE 1

| | unit | equation | embodiment 1 | | embodiment 2 | embodiment 3 | | embodiment 4 | embodiment 5 | |
|---|---|---|---|---|---|---|---|---|---|---|
| θ2-θ1 | (°) | equation | 48.71 | | 48.71 | 49.72 | | 49.72 | 49.617 | |
| | | (4) | | | | | | | | |
| θ4-θ3 | (°) | equation | 11.61 | | 11.61 | 3.68 | | 3.68 | 152.905 | |
| | | (5) | | | | | | | | |
| | | | optical | optical | optical | optical | optical | optical | optical | optical |
| | | | path 1 | path 2 | path 1 | path 1 | path 2 | path 2 | path 1 | path 2 |
| entrance pupil | (mm) | | 40 | 40 | 40 | 40 | 40 | 40 | 40 | 40 |
| diameter D | | | | | | | | | | |
| half angles | (°) | | 0.4 | 1 | 0.4 | 0.5 | 1 | 1.6 | 0.8 | 1 |
| of view φ_{X} | | | | | | | | | | |
| half angles | (°) | | 0.4 | 1 | 0.4 | 0.5 | 1 | 1.2 | 0.8 | 1 |
| of view φ_{Y} | | | | | | | | | | |
| image height | (mm) | | 1.33 | 4 | 1.33 | 2.165 | 4 | 3.19 | 2.13 | 3.59 |
| of the image | | | | | | | | | | |
| surface H_{X} | | | | | | | | | | |
| image height | (mm) | | −1.33 | 4 | 1.33 | 2.1 | 4 | 2.4 | 1.9 | 3.8 |
| of the image | | | | | | | | | | |
| surface H_{Y} | | | | | | | | | | |
| paraxial focal | (mm) | equation | 190.37 | 229.21 | 190.37 | 248.39 | 229.13 | 114.32 | 153.25 | 205.43 |
| length to the | | (2) | | | | | | | | |
| primary image | | | | | | | | | | |
| plane F_{X} | | | | | | | | | | |
| paraxial focal | (mm) | equation | 190.47 | 229.14 | 190.47 | 240.23 | 229.2 | 114.52 | 137.62 | 216.77 |
| length to the | | (2) | | | | | | | | |
| primary image | | | | | | | | | | |
| plane F_{Y} | | | | | | | | | | |
| mean value | (mm) | | 190.42 | 229.18 | 190.42 | 244.31 | 229.17 | 114.42 | 145.44 | 211.1 |
| of F | | | | | | | | | | |
| L | (mm) | | 9.97 | — | 9.97 | 13.51 | — | — | 10.26 | — |
| (F/D)_{X} | | equation | 4.76 | 5.728 | 4.76 | 6.21 | 5.73 | 2.86 | 3.83 | 5.14 |
| | | (3) | | | | | | | | |
| (F/D)_{Y} | | equation | 4.76 | 5.73 | 4.76 | 6.01 | 5.73 | 2.86 | 3.44 | 5.42 |
| | | (3) | | | | | | | | |
| L/F | | equation | 0.0524 | — | 0.0524 | 0.0553 | — | — | 0.0705 | — |
| | | (1) | | | | | | | | |

Accordingly, with the decentering optical system according to this embodiment, the Equations (1) through (5) are satisfied, and furthermore the Equations (1b) through (4b) and (5a) are also satisfied.

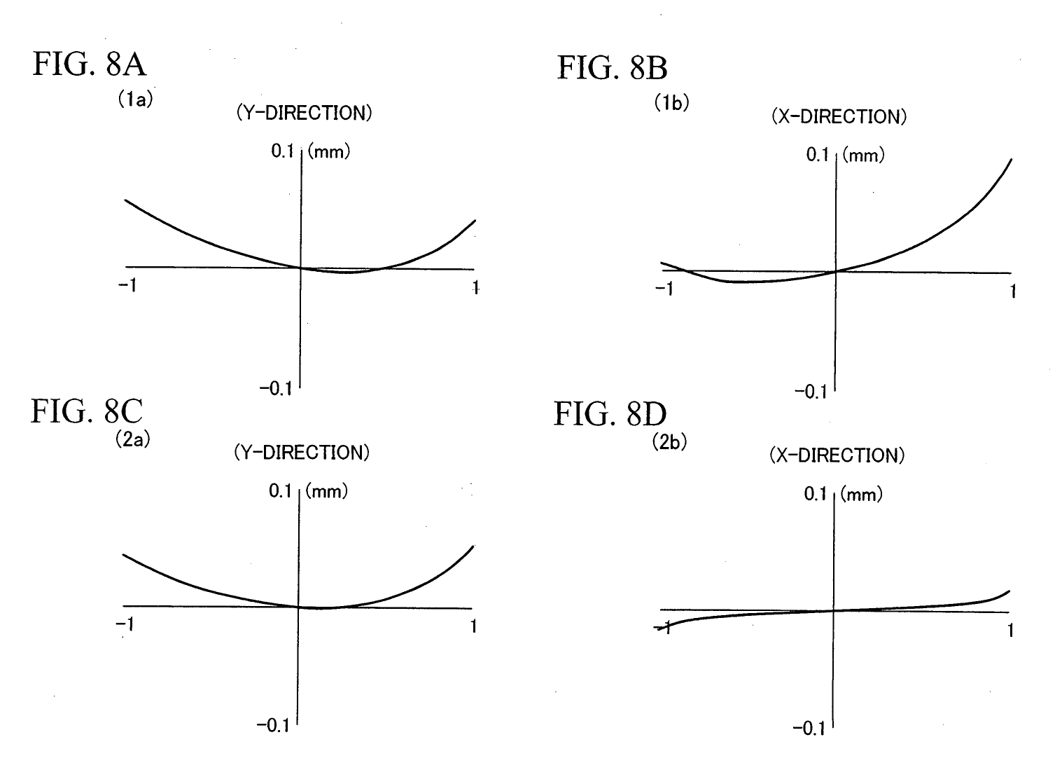

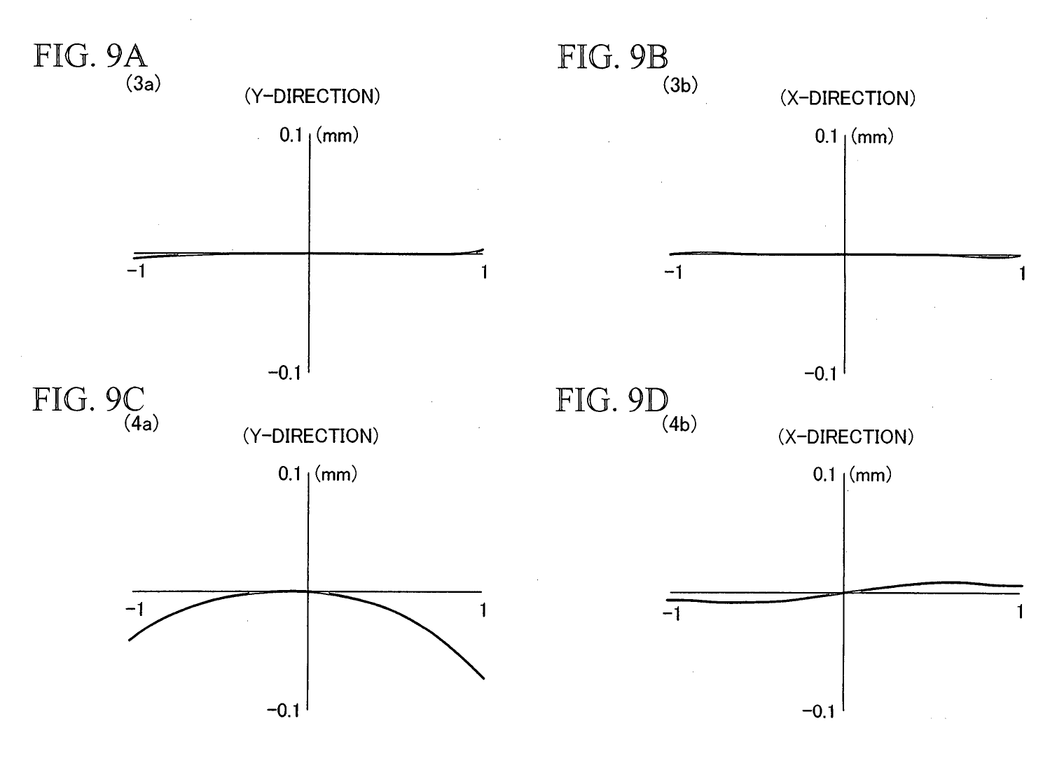

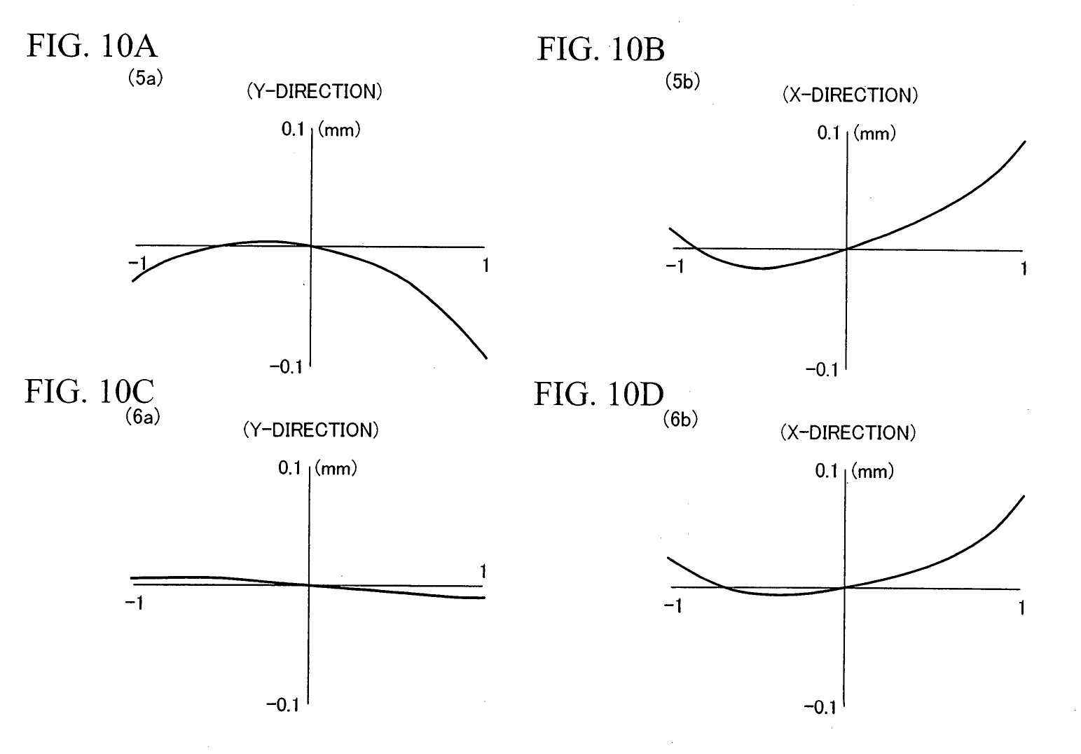

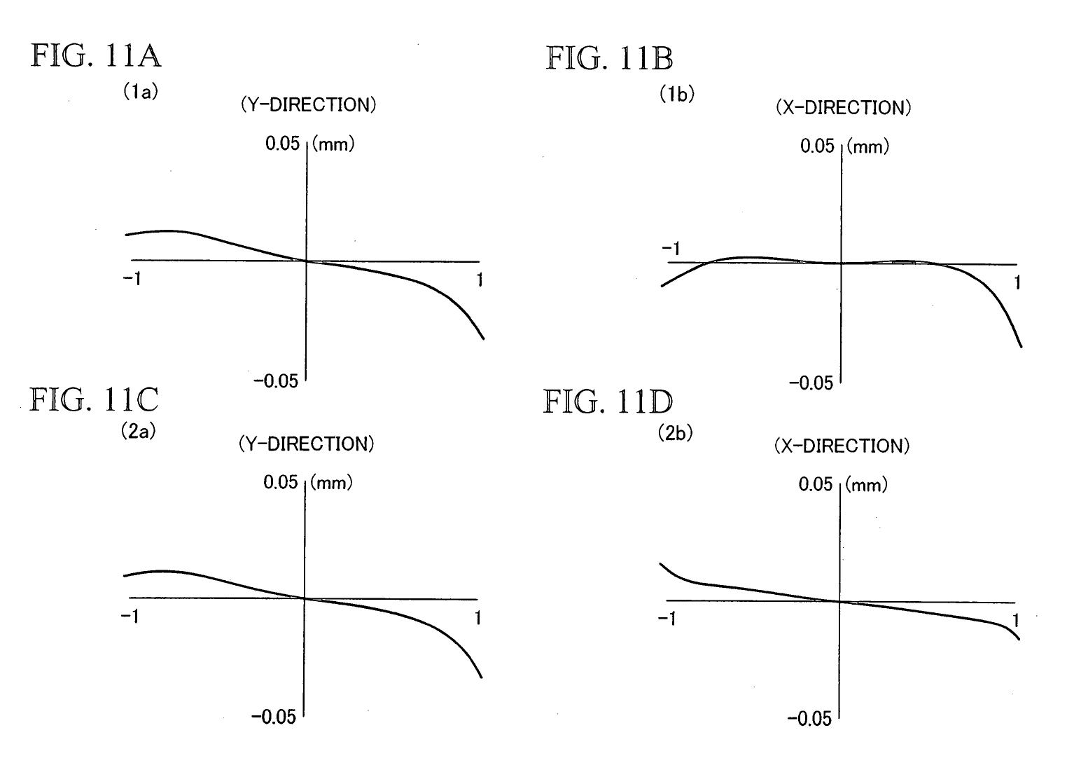

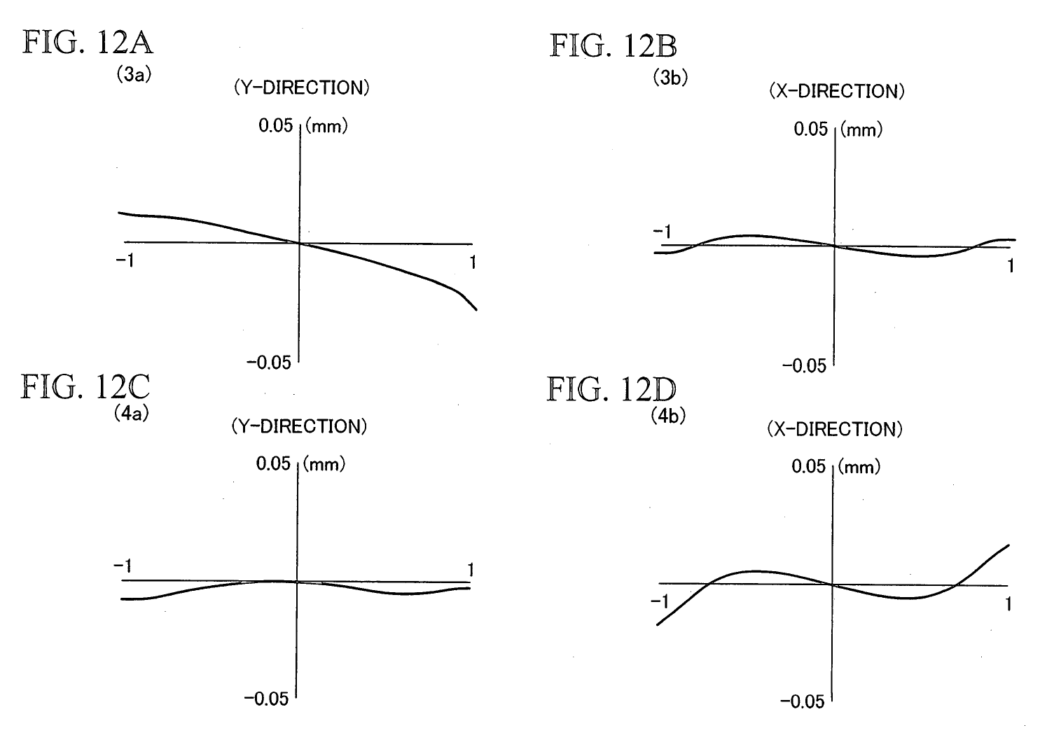

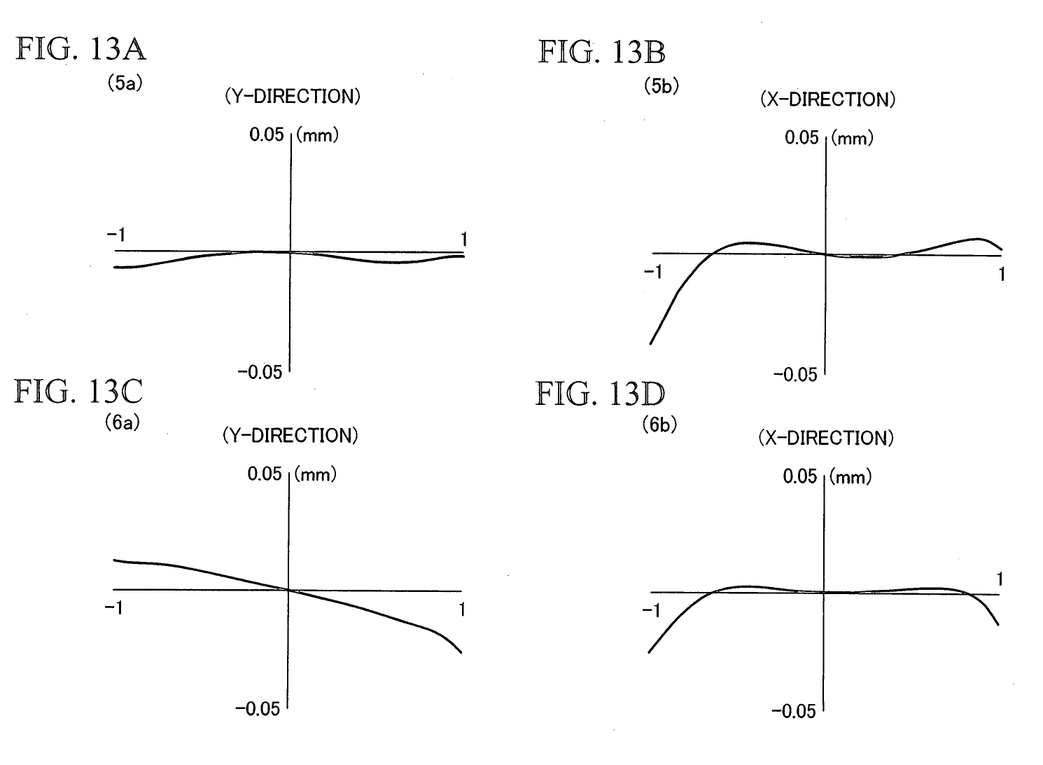

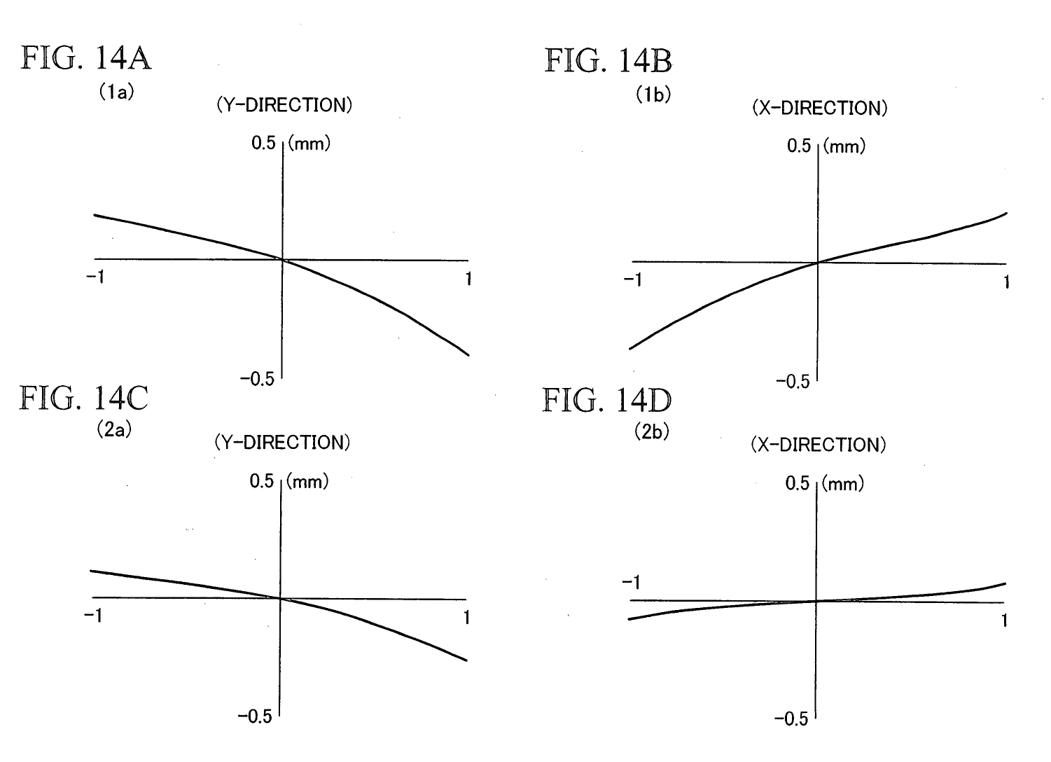

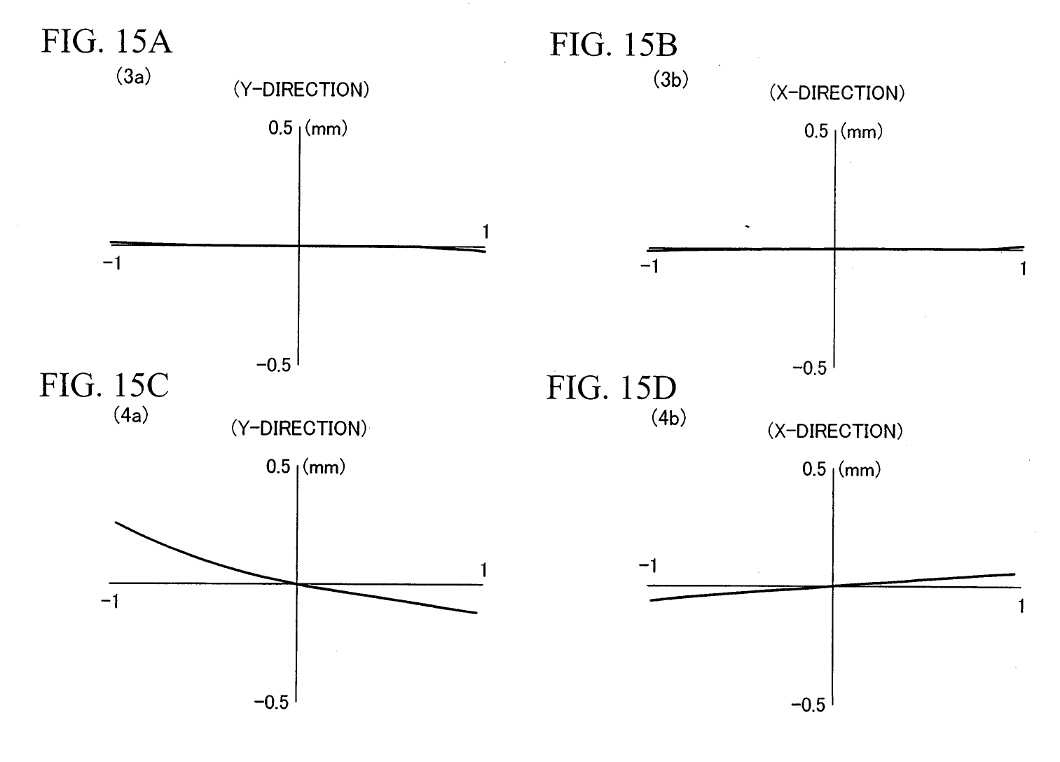

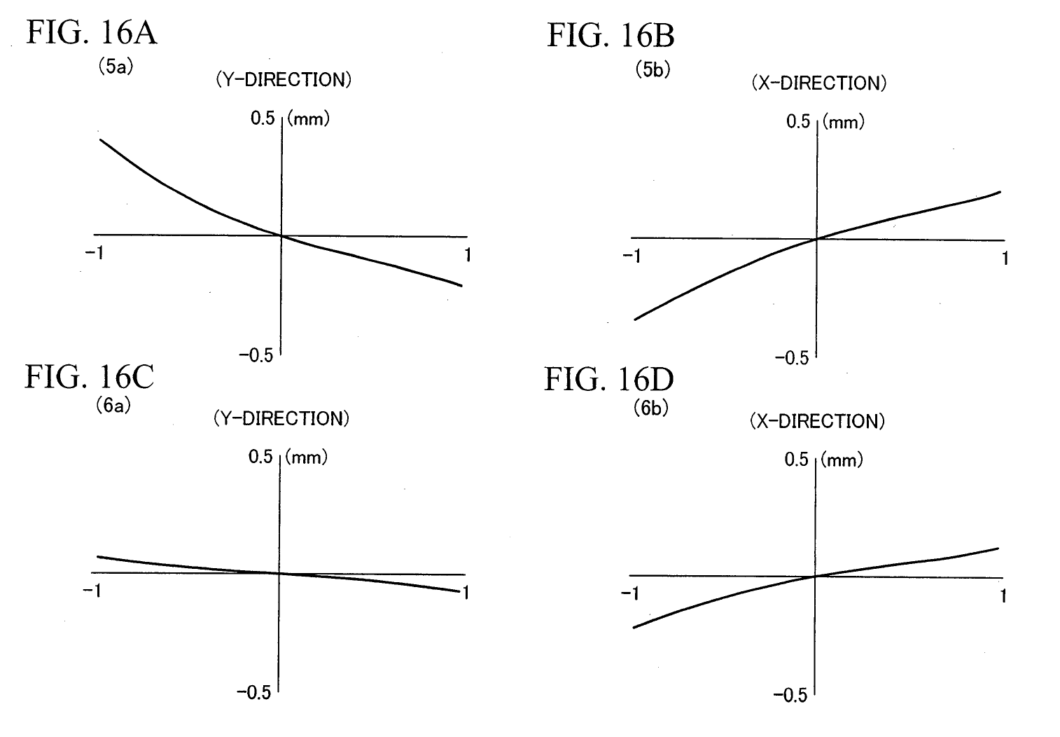

Furthermore, the horizontal aberration diagrams for this first preferred numerical value embodiment in the conditions of the above described Table 1 are shown in FIGS. 8A through 10D (for the optical path 1), and in FIGS. 1A through 13D (for the optical path 2). As for the notations (1a), (1b), . . . . (6a), (6b) appended in these figures, the symbol “a” indicates the Y axis direction, the symbol “b” indicates the X axis direction, and the symbols “1” through “6” correspond to the angle of view of the luminous flux. The combinations of angle of view in correspondence to appended symbols are as given below.

| | Y AXIS direction half | X AXIS direction half |
|---|---|---|
| Symbol | angle of view | angle of view |
| 1 | − \| φY \| | + \| φX \| |
| 2 | − \| φY \| | 0 |
| 3 | 0 | 0 |
| 4 | + \| φY \| | 0 |
| 5 | + \| φY \| | + \| φX \| |
| 6 | 0 | + \| φX \| |

In other words, the symbol “3” denotes horizontal aberration upon the optical axis.

In these figures, the aperture ratio is shown along the horizontal axis, and the horizontal aberration at a wavelength of 780 nm of the Y-Z plane (the Y direction) and of the X-Z plane (the X direction) are shown along the vertical axis, with the symbols “a” and “b” respectively appended. The units of horizontal aberration are (mm). These are also common to all of FIGS. 14A through 16D below.

As will be understood from FIGS. 8A through 10D, a satisfactory aberration characteristic is obtained for any half angle of view, with the horizontal aberration being kept within the range of ±0.1 mm (for the optical path 1), and ±0.05 mm (for the optical path 2).

It should be understood that the ideal lens of surface number 9 is one which is used as an expedient for displaying the aberration of only the decentering optical system.

### The Second Preferred Numerical Value Embodiment

Next, a second preferred numerical value embodiment which is related to the first variant example of the decentering optical system according to the first embodiment of the present invention described above will be explained with reference to FIG. 3.

The structural parameters of the optical system according to this second preferred numerical value embodiment are shown below.

Since the transmission optical path is the same as the optical path 2 of the first preferred numerical value embodiment described above, description thereof will be omitted here, and only the optical path which is pursued by the luminous flux which is reflected by the splitting surface 6 (the optical path 1) will be described. The coordinate system and so on are the same as in the first preferred numerical value embodiment described above.

Furthermore, with this second preferred numerical value embodiment, since the refractive indexes of the prism 15 and the lens 17 are the same, refraction does not take place at the joining surface 16. Due to this, the joining surface 16 is not shown or discussed below.

Yet further, in the following, FFS[1] through FFS[4] and eccentricity [1] through eccentricity [5] have the same values as shown above for the first preferred numerical value embodiment. Due to this, they are not shown or discussed below.

(optical path 1)

| Surface | | | | | |
|---|---|---|---|---|---|
| Number | Curvature | Surface | | | |
| Body | Radius | Gap | | Refractive | Abbe |
| Surface | ∞ | ∞ | Eccentricity | Index | Number |
| 1 | ∞ (iris | d₁ = 2.00 | | | |
| | surface) | | | | |
| 2 | FFS[1] | d₂ = 0.00 | eccentricity [1] | n₁ = 1.5254 | ν₁ = 56.2 |
| 3 | FFS[2] | d₃ = 0.00 | eccentricity [2] | n₂ = 1.5254 | ν₂ = 56.2 |
| 4 | FFS[3] | d₄ = 0.00 | eccentricity [3] | n₃ = 1.5254 | ν₃ = 56.2 |
| 5 | FFS[4] | d₅ = 0.00 | eccentricity [4] | n₄ = 1.5254 | ν₄ = 56.2 |
| 6 | ∞ (primary | d₆ = 0.00 | eccentricity [5] | n₅ = 1.5254 | ν₅ = 56.2 |
| | image plane) | | | | |
| 7 | r₁ = 5.161 | d₇ = 0.00 | eccentricity [6] | | |
| 8 | ∞ (exit pupil) | d₈ = 10.00 | | | |
| 9 | ∞ (ideal lens) | d₉ = 10.00 | | | |
| image | ∞ | d₁₀ = 0.00 | | | |
| plane | | | | | |

| | | | |
|---|---|---|---|
| eccentricity [6]: | X = 0.00 | Y = 40.91 | Z = 66.97 |
| | α = −122.92 | β = 0.00 | γ = 0.00 |

In the same way as with the results shown in Table 1 for the first preferred numerical value embodiment, with the decentering optical system of this embodiment as well, the Equations (1) through (5) are satisfied, and furthermore the Equations (1b) through (4b) and (5a) are also satisfied. Moreover, an optical system was obtained which had substantially the same optical characteristics as the first preferred numerical value embodiment.

Yet further, the horizontal aberration diagrams for this second preferred numerical value embodiment under the conditions shown in the above Table 1 are shown in FIGS. 14A through 16D. The notations, axes, units, and so on in these figures are the same as in the case of the first preferred numerical value embodiment, described above.

As will be understood from FIGS. 14A through 16D, a satisfactory aberration characteristic is obtained for any half angle of view, with the horizontal aberration being kept within the range of ±0.5 mm.

It should be understood that the ideal lens of surface number 9 is one which is used as an expedient for displaying the aberration of only the decentering optical system.

### The Third Preferred Numerical Value Embodiment

Next, a third preferred numerical value embodiment, which is related to an example of the decentering optical system according to the second embodiment of the present invention described above, will be explained with reference to FIG. 4A.

The structural parameters of the optical system according to this third preferred numerical value embodiment are shown below.

The optical path 1 is the optical path which is pursued by the luminous flux which is reflected by the splitting surface 24, while the optical path 2 is the optical path which is pursued by the luminous flux which passes through the splitting surface 24. The coordinate system and so on are the same as in the first preferred numerical value embodiment described above.

(optical path 1)

| Surface | | | | | |
|---|---|---|---|---|---|
| Number | Curvature | Surface | | | |
| Body | Radius | Gap | | Refractive | Abbe |
| Surface | ∞ | ∞ | Eccentricity | Index | Number |
| 1 | ∞ (iris | d₁ = 2.00 | | | |
| | surface) | | | | |
| 2 | FFS[1] | d₂ = 0.00 | eccentricity [1] | n₁ = 1.5254 | ν₁ = 56.2 |
| 3 | FFS[2] | d₃ = 0.00 | eccentricity [2] | n₂ = 1.5254 | ν₂ = 56.2 |
| 4 | FFS[3] | d₄ = 0.00 | eccentricity [3] | n₃ = 1.5254 | ν₃ = 56.2 |
| 5 | FFS[4] | d₅ = 0.00 | eccentricity [4] | n₄ = 1.5254 | ν₄ = 56.2 |
| 6 | ∞ (primary | d₆ = 0.00 | eccentricity [5] | n₅ = 1.5254 | ν₅ = 56.2 |
| | image plane) | | | | |
| 7 | FFS[5] | d₇ = 0.00 | eccentricity [6] | | |
| 8 | ∞ (exit pupil) | d₈ = 10.00 | eccentricity [7] | | |
| 9 | r₉ = 9.2386 | d₉ = 5.00 | | n₆ = 1.5168 | ν₆ = 64.1 |
| 10 | r₁₀ = −15.855 | d₁₀ = 9.88 | | | |
| image | ∞ | d₁₁ = 0.00 | | | |
| plane | | | | | |

| | |
|---|---|
| FFS[1]: | C₄ = 1.3226 × 10⁻², C₆ = 3.4209 × 10⁻³, C₈ = 5.4391 × 10⁻⁵, |
| | C₁₀ = 1.7980 × 10⁻⁵, C₁₁ = 1.1213 × 10⁻⁶, C₁₃ = −5.7590 × 10⁻⁷, |
| | C₁₅ = 4.5880 × 10⁻⁷, C₁₇ = 2.3876 × 10⁻⁸, C₁₉ = 2.1772 × 10⁻⁸, |
| | C₂₁ = −2.9474 × 10⁻⁹ |
| FFS[2]: | C₄ = 1.1521 × 10⁻³, C₆ = −3.2517 × 10⁻³, C₈ = 3.6459 × 10⁻⁵, |
| | C₁₀ = −1.6875 × 10⁻⁵, C₁₁ = −8.9896 × 10⁻⁷, C₁₃ = −4.2894 × 10⁻⁷, |
| | C₁₅ = 7.5657 × 10⁻⁹, C₁₇ = −3.8729 × 10⁻⁸, C₁₉ = −5.9025 × 10⁻¹⁰, |
| | C₂₁ = −2.8563 × 10⁻¹⁰ |
| FFS[3]: | C₄ = −3.2881 × 10⁻³, C₆ = −8.6575 × 10⁻³, C₈ = 6.7149 × 10⁻⁶, |
| | C₁₀ = −7.0663 × 10⁻⁵, C₁₁ = −7.4101 × 10⁻⁶, C₁₃ = −7.4085 × 10⁻⁶, |
| | C₁₅ = 1.5688 × 10⁻⁶, C₁₇ = −3.8226 × 10⁻⁷, C₁₉ = −1.1340 × 10⁻⁷, |
| | C₂₁ −2.4770 × 10⁻⁸ |
| FFS[4]: | C₄ = 6.3290 × 10⁻⁴, C₆ = 3.2583 × 10⁻⁴, C₈ = 1.4396 × 10⁻⁵, |
| | C₁₀ = 8.1710 × 10⁻⁶, C₁₁ = −3.8600 × 10⁻⁶, C₁₃ = −1.7106 × 10⁻⁶, |
| | C₁₅ = −1.5518 × 10⁻⁷, C₁₇ = −9.0781 × 10⁻⁷, C₁₉ = −3.3000 × 10⁻⁷, |
| | C₂₁ = −1.7745 × 10⁻⁷ |
| FFS[5]: | C₄ = 7.2252 × 10⁻², C₆ = 6.6113 × 10⁻², C₈ = 2.4499 × 10⁻³, |
| | C₁₀ = 2.0059 × 10⁻³, C₁₁ = 1.5862 × 10⁻⁵, C₁₃ = 2.0057 × 10⁻⁴, |

| | | | |
|---|---|---|---|
| eccentricity [1]: | X = 0.00 | Y = 0.00 | Z = 12.36 |
| | α = −18.40 | β = 0.00 | γ = 0.00 |
| eccentricity [2]: | X = 0.00 | Y = −4.91 | Z = 56.07 |
| | α = −30.02 | β = 0.00 | γ = 0.00 |
| eccentricity [3]: | X = 0.00 | Y = 25.31 | Z = 33.81 |
| | α = −79.74 | β = 0.00 | γ = 0.00 |
| eccentricity [4]: | X = 0.00 | Y = −31.69 | Z = 17.62 |
| | α = −113.95 | β = 0.00 | γ = 0.00 |
| eccentricity [5]: | X = 0.00 | Y = 19.42 | Z = 49.63 |
| | α = −121.87 | β = 0.00 | γ = 0.00 |
| eccentricity [6]: | X = 0.00 | Y = 36.82 | Z = 60.50 |
| | α = −110.26 | β = 0.00 | γ = 0.00 |
| eccentricity [7]: | X = 0.00 | Y = 48.34 | Z = 69.60 |
| | α = 51.68 | β = 0.00 | γ = 0.00 |

(optical path 2)

| Surface | | | | | |
|---|---|---|---|---|---|
| Number | Curvature | Surface | | | |
| Body | Radius | Gap | | Refractive | Abbe |
| Surface | ∞ | ∞ | Eccentricity | Index | Number |
| 1 | ∞ (iris | d₁ = 2.00 | | | |
| | surface) | | | | |
| 2 | FFS[1] | d₂ = 0.00 | eccentricity [1] | n₁ = 1.5254 | ν₁ = 56.2 |
| 3 | FFS[2] | d₃ = 0.00 | eccentricity [2] | n₂ = 1.5254 | ν₂ = 56.2 |
| 4 | FFS[3] | d₄ = 0.00 | eccentricity [3] | n₃ = 1.5254 | ν₃ = 56.2 |
| 5 | FFS[4] | d₅ = 0.00 | eccentricity [4] | n₄ = 1.5254 | ν₄ = 56.2 |
| image | ∞ | d₁₁ = 0.00 | eccentricity [8] | | |
| plane | | | | | |

| | | | |
|---|---|---|---|
| eccentricity [8]: | X = 0.00 | Y = −66.96 | Z = 10.37 |
| | α = 74.38 | β = 0.00 | γ = 0.00 |

In the same way as with the results shown in Table 1 for the first preferred numerical value embodiment, with the decentering optical system of this third preferred numerical value embodiment as well, Equations (1) through (5) are satisfied, and moreover Equations (1b) through (4b) and (5a) are satisfied as well.

### The Fourth Preferred Numerical Value Embodiment

Next, a fourth preferred numerical value embodiment, which is related to an example of the decentering optical system according to the second embodiment of the present invention described above, will be explained with reference to FIG. 4B.

The structural parameters of the optical system according to this fourth preferred numerical value embodiment are shown and described below.

Since the optical path 1 is the same as the optical path 1 of the third preferred numerical value embodiment described above, description thereof will be omitted here, and only the optical path which is pursued by the luminous flux which passes through the splitting surface 24 (the optical path 1) will be described. The coordinate system and so on is the same as in the first preferred numerical value embodiment described above.

Furthermore, in the following, FFS[1] through FFS[4] and eccentricity [1] through eccentricity [4] have the same values as shown above for the third preferred numerical value embodiment. Due to this, they are not shown or discussed below.

It should be understood that the light reception section corresponds to a 1/3 inch CCD, and is 1.6° horizontally by 1.2° vertically.

(optical path 2)

| Surface | | | | | |
|---|---|---|---|---|---|
| Number | Curvature | Surface | | | |
| Body | Radius | Gap | | Refractive | Abbe |
| Surface | ∞ | ∞ | Eccentricity | Index | Number |
| 1 | ∞ (iris | d₁ = 2.00 | | | |
| | surface) | | | | |
| 2 | FFS[1] | d₂ = 0.00 | eccentricity [1] | n₁ = 1.5254 | ν₁ = 56.2 |
| 3 | FFS[2] | d₃ = 0.00 | eccentricity [2] | n₂ = 1.5254 | ν₂ = 56.2 |
| 4 | FFS[3] | d₄ = 0.00 | eccentricity [3] | n₃ = 1.5254 | ν₃ = 56.2 |
| 5 | FFS[4] | d₅ = 0.00 | eccentricity [4] | n₄ = 1.5254 | ν₄ = 56.2 |
| 12 | ∞ | d₁₂ = 0.00 | eccentricity [8] | | |
| 13 | r₁₃ = 15.07 | d₁₃ = 5.17 | | n₇ = 1.5163 | ν₇ = 64.1 |
| 14 | r₁₄ = −441.02 | d₁₄ = 0.00 | | | |
| image | ∞ | d₁₁ = 0.00 | eccentricity [9] | | |
| plane | | | | | |

| | | | |
|---|---|---|---|
| eccentricity [8]: | X = 0.00 | Y = −39.37 | Z = 16.29 |
| | α = −100.05 | β = 0.00 | γ = 0.00 |
| eccentricity [9]: | X = 0.00 | Y = −55.02 | Z = 15.00 |
| | α = 79.37 | β = 0.00 | γ = 0.00 |

In the same way as with the results shown in Table 1 for the first preferred numerical value embodiment, with the decentering optical system of this fourth preferred numerical value embodiment as well, Equations (1) through (5) are satisfied, and moreover Equations (1b), (2b), (4b) and (5a) are satisfied as well.

### The Fifth Preferred Numerical Value Embodiment

Next, a fifth preferred numerical value embodiment, which is related to an example of the decentering optical system according to the third embodiment of the present invention described above, will be explained with reference to FIGS. 6A and 6B.

The structural parameters of the optical system according to this fifth preferred numerical value embodiment are shown below.

The optical path 1 is the optical path which is pursued by the luminous flux which is reflected by the splitting surface 34, while the optical path 2 is the optical path which is pursued by the luminous flux which passes through the splitting surface 34. The coordinate system and so on are the same as in the first preferred numerical value embodiment described above.

(optical path 1)

| Surface | | | | | |
|---|---|---|---|---|---|
| Number | Curvature | Surface | | | |
| Body | Radius | Gap | | Refractive | Abbe |
| Surface | ∞ | ∞ | Eccentricity | Index | Number |
| 1 | ∞ (iris | d₁ = 2.00 | | | |
| | surface) | | | | |
| 2 | FFS[1] | d₂ = 0.00 | eccentricity [1] | n₁ = 1.5254 | ν₁ = 56.2 |
| 3 | FFS[2] | d₃ = 0.00 | eccentricity [2] | n₂ = 1.5254 | ν₂ = 56.2 |
| 4 | FFS[3] | d₄ = 0.00 | eccentricity [3] | n₃ = 1.5254 | ν₃ = 56.2 |
| 5 | FFS[4] | d₅ = 0.00 | eccentricity [4] | n₄ = 1.5254 | ν₄ = 56.2 |
| 6 | ∞ (primary | d₆ = 0.00 | eccentricity [5] | n₅ = 1.5254 | ν₅ = 56.2 |
| | image plane) | | | | |
| 7 | aspheric | d₇ = 0.00 | eccentricity [6] | | |
| | surface [1] | | | | |
| 8 | ∞ (exit pupil) | d₈ = 0.00 | eccentricity [7] | | |
| 9 | r₉ = 15.71 | d₉ = 5.20 | eccentricity [8] | n₆ = 1.5168 | ν₆ = 64.1 |
| 10 | aspheric | d₁₀ = 0.00 | | | |
| | surface [2] | | | | |
| image | ∞ | d₁₁ = 0.00 | eccentricity [9] | | |
| plane | | | | | |

| | |
|---|---|
| FFS[1]: | C₄ = 1.3526 × 10⁻², C₆ = 6.3108 × 10⁻³, C₈ = 3.7095 × 10⁻⁵, |
| | C₁₀ = −4.2521 × 10⁻⁵, C₁₁ = 1.2401 × 10⁻⁶, C₁₃ = 7.8852 × 10⁻⁷, |
| | C₁₅ = 6.1274 × 10⁻⁸, C₁₇ = 2.6340 × 10⁻⁸, C₁₉ = 2.4319 × 10⁻⁹, |
| | C₂₁ = −7.0736 × 10⁻⁹ |
| FFS[2]: | C₄ = 1.8780 × 10⁻³, C₆ = −2.7373 × 10⁻³, C₈ = 5.9151 × 10⁻⁵, |
| | C₁₀ = −3.4196 × 10⁻⁵, C₁₁ = −1.2614 × 10⁻⁶, C₁₃ = −2.8139 × 10⁻⁷, |
| | C₁₅ = −3.1897 × 10⁻⁷, C₁₇ = −3.6084 × 10⁻⁸, C₁₉ = −7.0850 × 10⁻⁹, |
| | C₂₁ = −7.2774 × 10⁻¹⁰ |
| FFS[3]: | C₄ = −2.8320 × 10⁻³, C₆ = −1.2351 × 10⁻², C₈ = 9.7126 × 10⁻⁵, |
| | C₁₀ = −1.9874 × 10⁻⁴, C₁₁ = −1.0072 × 10⁻⁵, C₁₃ = −1.6170 × 10⁻⁵, |
| | C₁₅ = −1.2865 × 10⁻⁵, C₁₇ = −1.1726 × 10⁻⁷, C₁₉ = 9.0514 × 10⁻⁸, |
| | C₂₁ = 6.1825 × 10⁻⁷ |
| FFS[4]: | C₄ = −3.7190 × 10⁻³, C₆ = −5.6577 × 10⁻³, C₈ = −2.6053 × 10⁻⁵, |
| | C₁₀ = −2.0448 × 10⁻⁵, C₁₁ = −6.3260 × 10⁻⁶, C₁₃ = −3.7161 × 10⁻⁶, |
| | C₁₅ = −8.8217 × 10⁻⁷, C₁₇ = 4.3772 × 10⁻⁸, C₁₉ = 4.5824 × 10⁻⁷, |
| | C₂₁ = 5.6846 × 10⁻⁷ |
| aspheric | c = −5.72, k = −6.7182 × 10⁻¹, A = 2.6209 × 10⁻⁴ |
| surface [1]: | B = −1.2726 × 10⁻⁵, C = 2.1221 × 10⁻⁷ |
| aspheric | c = −8.08, k = −9.2333 × 10⁻¹, A = 3.6144 × 10⁻⁴, |
| surface [2]: | B = −2.3069 × 10⁻⁷ |

| | | | |
|---|---|---|---|
| eccentricity [1]: | X = 0.00 | Y = 0.00 | Z = 13.12 |
| | α = −16.93 | β = 0.00 | γ = 0.00 |
| eccentricity [2]: | X = 0.00 | Y = −5.05 | Z = 62.24 |
| | α = −28.65 | β = 0.00 | γ = 0.00 |
| eccentricity [3]: | X = 0.00 | Y = 26.15 | Z = 37.36 |
| | α = −78.27 | β = 0.00 | γ = 0.00 |
| eccentricity [4]: | X = 0.00 | Y = −37.42 | Z = 20.20 |
| | α = −134.70 | β = 0.00 | γ = 0.00 |
| eccentricity [5]: | X = 0.00 | Y = −30.28 | Z = 45.55 |
| | α = 25.04 | β = 0.00 | γ = 0.00 |
| eccentricity [6]: | X = 0.00 | Y = −25.69 | Z = 60.44 |
| | α = 18.21 | β = 0.00 | γ = 0.00 |
| eccentricity [7]: | X = 0.00 | Y = −23.77 | Z = 68.33 |
| | α = 17.25 | β = 0.00 | γ = 0.00 |
| eccentricity [8]: | X = 0.00 | Y = −19.94 | Z = 77.64 |
| | α = 14.88 | β = 0.00 | γ = 0.00 |
| eccentricity [9]: | X = 0.00 | Y = −15.56 | Z = 92.58 |
| | α = 8.84 | β = 0.00 | γ = 0.00 |

(optical path 2)

| Surface | | | | | |
|---|---|---|---|---|---|
| Number | Curvature | Surface | | | |
| Body | Radius | Gap | | Refractive | Abbe |
| Surface | ∞ | ∞ | Eccentricity | Index | Number |
| 1 | ∞ (iris | d₁ = 2.00 | | | |
| | surface) | | | | |
| 2 | FFS[1] | d₂ = 0.00 | eccentricity [1] | n₁ = 1.5254 | ν₁ = 56.2 |
| 3 | FFS[2] | d₃ = 0.00 | eccentricity [2] | n₂ = 1.5254 | ν₂ = 56.2 |
| 4 | FFS[3] | d₄ = 0.00 | eccentricity [3] | n₃ = 1.5254 | ν₃ = 56.2 |
| 5 | FFS[4] | d₅ = 0.00 | eccentricity [4] | n₄ = 1.5254 | ν₄ = 56.2 |
| image | ∞ | d₁₂ = 0.00 | eccentricity [10] | | |
| plane | | | | | |

| | | | |
|---|---|---|---|
| eccentricity [10]: | X = 0.00 | Y = −59.47 | Z = 21.69 |
| | α = 91.53 | β = 0.00 | γ = 0.00 |

In the same way as with the results shown in Table 1 for the first preferred numerical value embodiment, with the decentering optical system of this third preferred numerical value embodiment as well, Equations (1) through (4) are satisfied, and moreover, for the optical path 1, Equations (1b), (2b), (3a), and (4b) are satisfied as well, while, for the optical path 2, Equations (1b) through (4b) are satisfied as well.

Although the present invention has been described above in terms of certain embodiments thereof, it is not to be considered as being limited to those particular embodiments. Various changes, omissions, substitutions, and so on can be made to the present invention, provided that its gist is not departed from. Accordingly, the present invention is not to be limited by the foregoing explanation, but only by the legitimate and proper range of the appended claims.

The beneficial operational effects obtained by the use of the decentering optical system, the optical transmitting device, the optical receiving device, and the optical system according to the present invention are summarized below.

(A) A decentering optical system of the present invention takes a substantially parallel beam as input light, including a prism whose refractive index is greater than 1, and: at the boundary surface of the prism, at least five optical surfaces, which are arranged so as to be mutually decentering or inclined, are formed, in order along one optical path in which the input light pursues, as a first surface, a second surface, a third surface, a fourth surface, and a fifth surface; at least two among the five optical surfaces are rotationally asymmetric surfaces; and upon an optical path along which the input light proceeds in order from the first surface to the fifth surface and is emitted to the exterior of the prism, along with at least one real image being formed interior of the prism, an exit pupil is formed at the exterior of the prism.

According to this optical system which includes the prism which is made from a medium which has a refractive index greater than 1, and upon the outer surface of which there are formed the at least 5 optical surfaces which are arranged so as to be mutually decentering or slanting, the input light which is substantially parallel proceeds along the optical path and passes through, in order, the first surface through the fifth surface. And after, by experiencing the optical action of these optical surfaces, a primary image is formed in the interior of the prism by imaging at least once, then the light is emitted to the exterior of the prism, and the exit pupil is formed.

Since, the exit pupil is formed directly at the exterior of the prism, and not via any other optical member, accordingly, by arranging various optical elements or the like in the neighborhood of the pupil, it is possible to manufacture a small sized optical system which is endowed with high functionality. In particular, by providing a light deflection device at the exit pupil position as an optical communication antenna, and by directing the luminous flux to a position detection sensor, it is possible to make the position detection mechanism which follows the angle of view of the input light for performing optical tracking more compact, and it is possible to reduce the number of lens structural components exterior to the prism. Since the luminous flux which arrives at the optical element passes through the same region as the exit pupil, it is possible to manage with a smaller the optical element, even if there is a change in the angle of view of the input light.

If the luminous flux after it has exited the exit pupil is to be made into a parallel beam, then it is desirable to be able to unify the sizes of the condensing lens and the like after splitting the optical path. Furthermore, in order to make the device more compact, it is desirable to cause the exit pupil to adjoin the exit surface of the prism.

Yet further, since at least two of the five optical surfaces are made as rotationally asymmetric surfaces, accordingly, if in particular the axial principal ray which passes through the center of the entrance pupil of this decentering optical system and arrives at the imaging surface center is incident eccentrically with respect to the decentering optical system, then it becomes possible to compensate decentering aberration of the trapezoidal deformation of the image caused by the eccentricity and inclination of the image surface and the like. In particular, in the case in which there are two rotationally asymmetric surfaces, it is possible to keep down the manufacturing cost.

It should be understood that, in this specification, “optical surface” means that appropriate processing is carried out upon a surface such as a body surface or a boundary surface with the medium, and the surface has been processed so as to obtain an optical operation such as, from the macro point of view, reflection, refraction, interference, polarization or the like of a luminous flux. In other words, the present inventors use this expression as a generic term for an optical element which is shaped as a surface, such as, for example, a reflective surface, a transmission surface, a refracting surface, a lens surface, a Fresnel lens surface, a prism surface, a filter surface, a polarizing surface, an optical surface, or the like. Accordingly, when counting the number of optical surfaces, it is not intended that a multi-layer boundary surface such as, for example, a coating layer, or a number of boundary layers each of which performs a micro-type optical operation, should be counted.

Since, as has been explained above, according to the decentering optical system of the present invention, a prism is provided which has five optical surfaces of which at least two are rotationally asymmetric surfaces, and an exit pupil is formed externally to the prism, accordingly, while being able comparatively to relax the demands for manufacturing accuracy, it is still possible to make the device more compact, even while it has a comparatively long focal length.

(B) Another decentering optical system according to the present invention takes a substantially parallel beam as input light, including a prism whose refractive index is greater than 1, and: at the boundary surface of the prism, at least five optical surfaces, which are arranged so as to be mutually decentering or inclined, are formed, in order along one optical path which the input light pursues, as a first surface, a second surface, a third surface, a fourth surface, and a fifth surface; at least one among the five optical surfaces is a splitting surface which splits the optical path of the input light into a transmission optical path and a reflection optical path; the reflection optical path is an optical path along which the input light proceeds in order from the first surface to the fifth surface and is emitted to the exterior of the prism; and at least one real image is formed within the prism upon the reflection optical path or upon the transmission optical path.

According to this decentering optical system, by providing at least one splitting surface, it is possible to split the optical path of the input light into a transmission optical path and a reflection optical path, without using any separate optical member. Due to this, it becomes possible to make the device more compact, and to reduce the number of components.

Furthermore, since the at least one real image (the primary image) is created within the prism, it is possible to control the spreading out of the luminous flux which is exited from the exit surface of the prism by selecting the power of the exit surface. For example, by selecting a surface which is endowed with an appropriate positive power for the exit surface, it is possible to make the luminous flux which is exited from the exit surface to be substantially parallel. Furthermore, by selecting a surface which is endowed with an appropriate positive power for the exit surface, it is possible to convert the light beam which is exited from the exit surface into convergent light, and it is possible to perform imaging exterior to the prism as well.

By unifying the exit surface with the prism in this manner, it is possible to emit divergent light, parallel light, or convergent light having an appropriate degree of spreading out or convergence to the exterior of the prism, while still making the device compact, so that it is possible to obtain an optical system which is endowed with a high level of functionality.

Furthermore, by receiving each of a plurality of luminous fluxes which are emitted to the exterior of the prism with a light reception element such as, for example, a CCD or a position detection sensor or the like, it is possible to obtain a plurality of items of information about the input light. Here, by information about the input light, there is meant an image of the input light, the inclination of the input light, an optical signal which is conveyed by the input light, or the like. It is also possible for this optical system to function as an optical tracking sensor of an optical system for free space optical communication or the like, using, for example, a light reception element as a position detection device for the input light. In such a case, by splitting the input light into two optical paths, and by changing the synthetic focal length of each of them, it becomes possible to use the input light while dividing it into one luminous flux for coarse tracking, and another luminous flux for fine tracking.

Since, as has been explained above, according to this other decentering optical system of the present invention, the prism is provided which has five optical surfaces, at least one surface whereof is made as a splitting surface, and it is arranged for at least one real image to be formed in the interior of the prism upon the path of the light which is emitted to the exterior of the prism after having proceeded to these five optical surfaces in order, accordingly, while being able comparatively to relax the demands for assembly accuracy, it is also possible to make the device more compact, while it nevertheless has a comparatively long focal length.

(C) With the decentering optical system according to (B) above, a luminous flux which has been emitted to the exterior of the prism may define an exit pupil.

In this case, one of the luminous fluxes which has been split is directed, directly and not via any other optical element, to the exterior of the prism, and defines the exit pupil. Accordingly, by disposing various types of optical element in the neighborhood of the exit pupil, it is possible to manufacture an optical system of small size and which is endowed with a high level of functionality. In particular, when constructing a system for use as an optical system for free space optical communication, by providing a light deflection device at the position of the exit pupil as such an optical element, and by directing the luminous flux to a position detection sensor, it is possible to construct a position detection mechanism which follows changes in the angle of view of the input light for performing optical tracking. Since the luminous flux which arrives at the optical element passes through substantially the same region as the exit pupil, accordingly it is possible to make the optical element more compact, even if there is a change in the angle of view of the input light.

Furthermore, it is desirable to make the luminous flux which defines the exit pupil into a parallel beam, since, in this case, splitting and condensing of the optical path and imaging become simple. Furthermore it is desirable, in order to make the device more compact, for the exit pupil to be made to adjoin the exit surface of the prism.

(D) With the decentering optical system according to (C) above: at least one real image may be formed upon the reflection optical path and interior of the prism; the exit pupil may be formed upon the reflection optical path and moreover exterior to the prism; and another real image may be formed upon the transmission optical path and moreover external to the prism.

In this case, it is possible to build an optical system which splits the input light into a reflection optical path and a transmission optical path, and which has an appropriate synthetic focal length upon each of these optical paths, due to the at least five, or at least two through four, optical surfaces. Accordingly it is possible to manufacture an optical system in which the luminous flux which is emitted from the exit pupil and the other real image have different shift speeds and shift ranges upon the appropriate light reception surface or imaging surface, according to variation of the angle of incidence.

Accordingly, it is possible to build an optical system which is endowed with a high degree of functionality, such as, for example, one in which a light deflection element is provided within the reflection optical path, so that information which has been collected from the input light upon the transmission optical path side is fed back to the light deflection element, thus controlling the reflected light.

Furthermore, since the exit pupil is formed upon the reflection optical path, it is convenient to arrange the optical element, such as, for example, a light deflection device. Accordingly, by selecting the power of the exit surface appropriately, it is possible to control the spreading out of the luminous flux which is emitted.

(E) With the decentering optical system according to (B) above, the axial principal ray of the luminous flux which has been reflected by the splitting surface may pursue an optical path which crosses over at least two of the axial principal rays in the interior of the prism.

In this case, the five optical surfaces are arranged so that the axial principal ray towards the fourth surface which has been reflected from the third surface and the axial principal ray towards the fifth surface which has been reflected from the fourth surface both cross over the axial principal ray which has passed through the first surface towards the second surface. Due to this, the axial principal ray from the second surface towards the third surface and the axial principal ray from the fourth surface towards the fifth surface also come to cross over one another.

In order to implement this type of optical path, it is necessary to arrange the various optical surfaces in the externally circumferential direction of the prism—for example, in this order: the first surface, the fourth surface, the second surface, the fifth surface, and the third surface. And at least neighboring optical surfaces are arranged so as to be decentering or inclined, and thereby this prism comes to constitute a decentering optical system.

In this case, it is possible to manufacture a compact structure, since the luminous flux within the prism pursues an optical path which crosses over in a three cornered shape and then once again doubles back over itself.

(F) With the decentering optical system according to (B) above: the first surface may be a transmission surface which transmits the input light to the interior of the prism; the second surface may be an internal reflection surface which reflects the luminous flux that has passed through the first surface; the third surface may be an internal reflection surface which reflects the luminous flux that has been reflected from the second surface; the fourth surface may be the splitting surface and splits the optical path of the luminous flux which has been reflected from the third surface into the transmission optical path and the reflection optical path; the fifth surface may be a transmission surface which passes the luminous flux which is pursuing the reflection optical path; at least two of the first surface through the fifth surface may be rotationally asymmetric surfaces; and, along with the at least one real image in the interior of the prism being formed upon the reflection optical path, another real image may be formed upon the transmission optical path and moreover on the exterior of the prism.

In this case, the same beneficial operational effects as described above are available with regard to the structure of the optical path. Furthermore, with regard to the point that the reflection optical path and the transmission optical path are formed by the splitting surface, except for the beneficial operational effect with regard to the exit pupil, again, the same beneficial operational effects as described above are available.

(G) With the decentering optical system according to (A) above, the axial principal ray towards the fourth surface which has been reflected from the third surface and the axial principal ray towards the fifth surface which has been reflected from the fourth surface may both cross over the axial principal ray towards the second surface which has passed through the first surface.

In this case, with regard to the structure of the optical path, irrespective of whether or not the fourth surface is a splitting surface, it is possible to obtain the same beneficial operational effects as in the case of the decentering optical system described in (E) above.

(H) With the decentering optical system according to (A) above, the second surface may include a rotationally asymmetric surface which is endowed with a positive power upon a plane which includes at least all the axial principal rays which are in the interior of the prism.

In this case, the input light which is incident upon the first surface as substantially parallel light is incident upon the second surface while still having a comparatively large luminous flux diameter, and here the input light is reflected by this rotationally asymmetric surface which is endowed with a positive power and which is provided eccentrically. Accordingly, by providing this rotationally asymmetric surface which is excellent with regard to aberration compensation capability, it is possible to alleviate the burden of aberration compensation in the later stages, and thus it is possible to manufacture an optical system which has satisfactory imaging performance.

(I) With the decentering optical system according to (A) above, the third surface may include a rotationally asymmetric surface which is endowed with a negative power upon a plane which includes at least all the axial principal rays which are in the interior of the prism.

In this case, since the third surface is endowed with a negative power, it is possible to compensate the spherical aberration and the coma aberration which are generated at the first surface. Furthermore, since it is possible to improve the Petzbar sum for the off-axis light beam, accordingly it is possible to operate effectively, in particular when the angle of view of the incident light is large, and it is possible to enhance the imaging performance. Yet further, it is possible to compensate the decentering aberration in a satisfactory manner, since this surface consists of a rotationally asymmetric surface.

Still further, if the concept for the decentering optical system described in (I) above is combined with the concept for the decentering optical system described in (H) above, then, by endowing the second surface with a positive power and the third surface with a negative power, an optical system of a telescopic lens type is constituted, and it is possible to make the prism more compact, since it is possible to make the distance to the imaging position short with respect to the focal length.

(J) With the decentering optical system according to (A) above, the at least one real image which is formed in the interior of the prism may be formed between the fourth surface and the fifth surface.

In this case, since at least one real image (the primary image) is formed between the fourth surface and the fifth surface, accordingly, by appropriately setting the distance from this real image to the fifth surface (the exit surface), it is possible to control the luminous flux diameter at the exit surface. As a result, control of the pupil diameter and of the pupil position becomes simple.

In particular, if an objective mirror of a telescopic lens or the like is used to define the exit pupil, then the desirable convenience is obtained, that, since it is possible to make the luminous flux which is exited from the exit surface no be a substantially parallel beam, it is possible to make the angular magnification up to the exit pupil to be large.

Even further, by controlling the power of the fifth surface, it becomes possible to form the exit pupil at any desired position on the image side of the exit surface.

(K) With the decentering optical system according to (A) above, when the paraxial focal length in the interior of the prism to the at least one real image is termed F, and the air converted length from the imaging position of the real image to the exit surface of the prism is termed L, the following Equation (1) may be satisfied:
0.01≦L/F≦0.3 (1)

In this case, the ratio L/F is kept within the range specified by Equation (1). Accordingly, the same beneficial operational effects are obtained, as those which were explained in the case of the decentering optical system described in (H) above.

If the ratio L/F is less than the lower limit value 0.01, then the distance from the primary image to the fifth surface is too short, and due to this the luminous flux diameter at the fifth surface becomes too small, so that it becomes difficult to form the exit pupil in the neighborhood of the exit surface.

On the other hand, if the ratio L/F is greater than the upper limit value of 0.3, then, since the distance from the primary image to the fifth surface becomes too long, the synthetic focal length of this decentering optical system becomes comparatively short, which is undesirable. In this case, if an attempt is made to make the synthetic focal length long, this is impossible without making the prism of large size.

It should be understood that it would be desirable for the range of the ratio L/F to be kept within a narrower range, in order, along with defining the exit pupil in a more appropriate position, to make a prism of a more appropriate size. It would be acceptable to make the upper limit 0.02 or 0.04, and to make the lower limit 0.15 or 0.1. For example, it would be desirable for the ratio L/F to be kept within the range specified by the following Equation (1a):
0.02≦L/F≦0.15 (1a)

Furthermore, it would be even more desirable for the ratio L/F to be kept within the range specified by the following Equation (1b):
0.04≦L/F≦0.1 (1b)

(L) With the decentering optical system according to (A) above, when the paraxial focal length in the interior of the prism to the at least one real image is termed F, the following Equation (2) may be satisfied:
60 (mm)≦F≦500 (mm) (2)

In this case, since the paraxial focal length F is kept to be within the above described range, it is possible to manufacture the decentering optical system with a logical range, and it is possible to make it more compact, and to achieve a reduction in its cost.

In other words, when the paraxial focal length F becomes long and exceeds the upper limit value of 500 mm, then, even though a medium of a refractive index which is greater than 1 is used, and even though the optical path is folded up, the prism becomes so large that processing becomes difficult. On the other hand, when the paraxial focal length F becomes short and is less than the lower limit value of 60 mm, then it becomes impossible to manifest the beneficial effects of folding up the optical path to a sufficient extent. On the other hand, by specifying the paraxial focal length F to be between these two limit values, it becomes possible reliably to avoid the above described type of problem, and it is possible to make the device with a logical range, and thus more compact; and it is also possible to anticipate a reduction in the cost of manufacture.

It should be understood that it would be desirable for the length of the paraxial focal length F, as compared to the length of the optical path, to be kept within a narrower range than the above described range, in order to make the device more compact with a good balance, and in order to make it possible to reduce the cost. For example, it would be more desirable for F to be kept within the range specified by the following Equation (2a):
80 (mm)≦F≦400 (mm) (2a)

Furthermore, it would be even more desirable for F to be kept within the range specified by the following Equation (1b):
100 (mm)≦F≦300 (mm) (2b)

(M) With the decentering optical system according to (A) above, when the paraxial focal length in the interior of the prism to the at least one real image is termed F, and the entrance pupil diameter is termed D, the ratio F/D may satisfy the following Equation (3):
2≦F/D≦15 (3)

Since, in this case, the ratio F/D of the paraxial focal length F to the entrance pupil diameter D is kept within the range specified by Equation (3), accordingly it is possible to manufacture a decentering optical system in a state in which an appropriate balance is struck.

In other words, if the ratio F/D becomes large and exceeds the upper limit value of 15, then, since the length of the optical path with respect to the entrance pupil diameter becomes too long, the prism becomes large, or this becomes an optical system of which the back focus is large, so that it is not possible to obtain a compact optical system. On the other hand, if the ratio F/D becomes small and drops below the lower limit value of 2, then the luminous flux diameter of the incident light becomes large with respect to the focal length, and the NA becomes large. As a result, the spherical aberration and the coma aberration and so on become large, and it becomes difficult to perform aberration compensation. Thus, by specifying that the ratio F/D should be between these two limit values, it becomes possible to avoid the problems described above, and to manufacture the decentering optical system in a state in which an appropriate balance has been struck.

It should be understood that it would be desirable for the range of the ratio F/D to be kept within a narrower range, in order to improve the balance of the decentering optical system. For example, it would be more desirable for the ratio F/D to be kept within the range specified by the following Equation (3a):
3≦F/D≦10 (3a)

Furthermore, it would be even more desirable for the ratio F/D to be kept within the range specified by the following Equation (3b):
4≦F/D≦8 (3b)

(N) With the decentering optical system according to (A) above, there may be further included at least one light condensing device which condenses a luminous flux which has been emitted from the prism at a light reception surface.

In this case, by providing the light condensing device which condenses the luminous flux which has been emitted from the prism at the light reception surface, it is possible to set the position and the size of the light reception surface to appropriate values.

(O) With the decentering optical system according to (B) above, there may be further included a lens which is disposed in the neighborhood of the exit surface of the reflection optical path, and which condenses or diverges a luminous flux which has been exited from the exit surface.

In this case, by providing the lens which condenses or diverges the luminous flux which has been emitted from the neighborhood of the exit surface of the reflection optical path, it becomes possible to control the widening of the emitted luminous flux which is emitted from the prism. For example if, due to a processing error or the like, the luminous flux which is emitted from the prism becomes diverging light, irrespective of whether it was designed for substantially parallel light to be emitted, then, by providing a positive lens in the neighborhood of the exit surface, it is possible to compensate for the problem, and to produce a parallel beam. Furthermore, according to requirements, it is possible to compensate the angle of divergence of the luminous flux to an appropriate value. Yet further, if the emitted light is converging light, by providing a negative lens, it is possible to compensate for this problem as well, and to produce a parallel beam.

Furthermore, it is possible to control the position of the exit pupil.

Therefore, by changing the characteristics of the lenses which are provided according to requirements, it becomes possible to utilize the prism for a wide range of applications.

(P) With the decentering optical system according to (O) above: both the exit surface of the reflection optical path and one lens surface of the lens may be planar; and the exit surface and the lens may be arranged so that the plane surfaces confront one another.

In this case, since the exit surface of the prism and the lens which is disposed in the neighborhood of this exit surface are positioned with their plane surfaces mutually confronting one another, it is possible to perform lens arrangement and fitting simply and moreover at high accuracy, and it is accordingly possible to construct this decentering optical system at a cheap price and with excellent flexibility.

It should be understood that, in order to reduce the influence of blurring due to dust and the like upon the surfaces of these elements, it is desirable for the position of the confronting plane to be displaced away from the imaging position of the primary surface.

(Q) With the decentering optical system according to (O) above, the exit surface of the reflection optical path and the lens may be mutually joined together.

In this case, the degree of freedom in selection of the power with a single prism is enhanced, since the exit surface and the plane of the lens are joined together. It should be understood that, as a method for performing this joining, any per se known technique may be used for gluing the lens to the prism. For example, it is possible to employ an adhesive for optical purposes, or the like. In this case, it would be acceptable to apply an appropriate coating to the joining surfaces, so as to control the transmission performance such as the transmission ratio for the luminous flux, the wavelength selection characteristic, and the like.

(R) One optical transmitting device of the present invention includes: a decentering optical system according to (A) above; and a light source section which emits a substantially parallel beam.

According to this optical receiving device, it is possible to obtain the same beneficial operational effects as in the case of the decentering optical system described in (A) above.

(S) With the optical transmitting device according to (R) above, there may be further included an optical path synthesis device for making the substantially parallel beam which is emitted from the light source section to be incident upon the exit pupil.

In this case, by providing the optical path synthesis device, it is possible to ensure that the substantially parallel beam which is emitted from the light source section is made to be incident simply upon the exit pupil, and it is possible to emit a substantially parallel beam from the first surface of the decentering optical system.

(T) With another optical transmitting device according to the present invention, there may be included: a decentering optical system according to (B) above; and a light source section which emits a substantially parallel beam.

According to this optical receiving device, it is possible to obtain the same beneficial operational effects, as in the case of the decentering optical system described in (B) above.

(U) One optical receiving device according to the present invention includes: a decentering optical system according to (A) above; and at least one position detection sensor which receives a luminous flux which has been emitted to the exterior of the prism of the decentering optical system, and detects the light reception position thereof.

According to this optical receiving device, the same beneficial operational effects are obtained as in the case of the decentering optical system described in (A) above; and, moreover, it becomes possible to detect the angle of view of the input light by detecting the position in which the light is received by the position detection sensor upon its light reception surface.

(V) Another optical receiving device according to the present invention includes: a decentering optical system according to (A) above; at least one light reception element which receives a luminous flux which has been emitted to the exterior of the prism of the decentering optical system; and an input signal controller which is connected to the light reception element.

According to this optical receiving device, the same beneficial operational effects are obtained, as in the case of the decentering optical system described in (A) above. Furthermore, it also becomes possible to receive the luminous flux which has been emitted from the decentering optical system with the light reception element, and to obtain information about the input light with the input signal controller.

(W) The optical system according to the present invention includes: an optical transmitting device which emits substantially parallel light; and an optical receiving device, which is disposed so as to confront the optical transmitting device with a certain distance between them, which receives the substantially parallel light as input light, and which includes a decentering optical system according to (A) above.

According to this optical system, the same beneficial operational effects are obtained, as in the case of the decentering optical system described in (A) above.

(X) With the optical system according to (W) above, at least one light reception surface of the optical receiving device may be formed by position detection sensor, and the optical system may perform optical acquisition and tracking based upon a position signal from the position detection sensor.

In this case, by providing the position detection sensor at the light reception surface, it is possible to perform optical acquisition and tracking at high accuracy.

(Y) With the optical system according to (W) above: the optical transmitting device may include an output signal controller; the optical receiving device may include an input signal controller; and free space optical communication may be performed by modulating a communication signal and sending and receiving it.

In this case, it is possible to perform free space optical communication at high accuracy and moreover with high efficiency. In particular, if optical acquisition and tracking is implemented, it is possible to perform free space optical communication in a more stabilized manner and with high reliability.

According to the optical transmitting device, the optical receiving device, and the optical system explained above, it becomes possible to perform free space optical communication at high accuracy and moreover with high efficiency, since the decentering optical system which has the above described structure is incorporated.

1. A decentering optical system which takes a substantially parallel beam as input light, comprising a prism whose refractive index is greater than 1, wherein:
at the boundary surface of the prism, at least five optical surfaces, which are arranged so as to be mutually decentering or inclined, are formed, in order along one optical path in which the input light pursues, as a first surface, a second surface, a third surface, a fourth surface, and a fifth surface;
at least two among the five optical surfaces are rotationally asymmetric surfaces; and
upon an optical path along which the input light proceeds in order from the first surface to the fifth surface and is emitted to the exterior of the prism, along with at least one real image being formed interior of the prism, an exit pupil is formed at the exterior of the prism.

2. A decentering optical system which takes a substantially parallel beam as input light, comprising a prism whose refractive index is greater than 1, wherein:
at the boundary surface of the prism, at least five optical surfaces, which are arranged so as to be mutually decentering or inclined, are formed, in order along one optical path in which the input light pursues, as a first surface, a second surface, a third surface, a fourth surface, and a fifth surface;
at least one among the five optical surfaces is a splitting surface which splits the optical path of the input light into a transmission optical path and a reflection optical path;
the reflection optical path is an optical path along which the input light proceeds in order from the first surface to the fifth surface and is emitted to the exterior of the prism; and
at least one real image is formed within the prism upon the reflection optical path or upon the transmission optical path.

3. The decentering optical system according to claim 2, wherein a luminous flux which has been emitted to the exterior of the prism forms an exit pupil.

4. The decentering optical system according to claim 3, wherein:
at least one real image is formed upon the reflection optical path and interior of the prism;
the exit pupil is formed upon the reflection optical path and moreover exterior of the prism; and
another real image is formed upon the transmission optical path and moreover external of the prism.

5. The decentering optical system according to claim 2, wherein the axial principal ray of the luminous flux which has been reflected by the splitting surface pursues an optical path which crosses over at least two of the axial principal rays in the interior of the prism.

6. The decentering optical system according to claim 2, wherein:
the first surface is a transmission surface which transmits the input light to the interior of the prism;
the second surface is an internal reflection surface which reflects the luminous flux that has passed through the first surface;
the third surface is an internal reflection surface which reflects the luminous flux that has been reflected from the second surface;
the fourth surface is the splitting surface which splits the optical path of the luminous flux which has been reflected from the third surface into the transmission optical path and the reflection optical path;
the fifth surface is a transmission surface which passes the luminous flux pursuing along the reflection optical path;
at least two of the first surface through the fifth surface are rotationally asymmetric surfaces; and
along with the at least one real image in the interior of the prism being formed upon the reflection optical path, another real image is formed upon the transmission optical path and moreover on the exterior of the prism.

7. The decentering optical system according to claim 1, wherein the axial principal ray towards the fourth surface which has been reflected from the third surface and the axial principal ray towards the fifth surface which has been reflected from the fourth surface both cross over the axial principal ray towards the second surface which has passed through the first surface.

8. The decentering optical system according to claim 1, wherein the second surface comprises a rotationally asymmetric surface which is endowed with a positive power upon a plane which includes at least all the axial principal rays which are in the interior of the prism.

9. The decentering optical system according to claim 1, wherein the third surface comprises a rotationally asymmetric surface which is endowed with a negative power upon a plane which includes at least all the axial principal rays which are in the interior of the prism.

10. The decentering optical system according to claim 1, wherein the at least one real image which is formed in the interior of the prism is formed between the fourth surface and the fifth surface.

11. The decentering optical system according to claim 1, wherein, when the paraxial focal length in the interior of the prism to the at least one real image is termed F, and the air converted length from the imaging position of the real image to the exit surface of the prism is termed L, the following Equation (1) is satisfied:
0.01≦L/F≦0.3 (1)

12. The decentering optical system according to claim 1, wherein, when the paraxial focal length in the interior of the prism to the at least one real image is termed F, the following Equation (2) is satisfied:
60 (mm)≦F≦500 (mm) (2)

13. The decentering optical system according to claim 1, wherein, when the paraxial focal length in the interior of the prism to the at least one real image is termed F, and the entrance pupil diameter is termed D, the ratio F/D satisfies the following Equation (3):
2≦F/D≦15 (3)

14. The decentering optical system according to claim 1, further comprising at least one light condensing device which condenses a luminous flux which has been emitted from the prism at a light reception surface.

15. The decentering optical system according to claim 2, further comprising a lens which is disposed in the neighborhood of the exit surface of the reflection optical path, and which condenses or diverges a luminous flux which has been exited from the exit surface.

16. The decentering optical system according to claim 15, wherein:
both the exit surface of the reflection optical path and one lens surface of the lens are planar; and
the exit surface and the lens are arranged so that the plane surfaces confront one another.

17. The decentering optical system according to claim 15, wherein the exit surface of the reflection optical path and the lens are mutually joined together.

18. An optical transmitting device, comprising: the decentering optical system according to claim 1; and a light source section which emits a substantially parallel beam.

19. An optical transmitting device according to claim 18, further comprising an optical path synthesis device for making the substantially parallel beam which is emitted from the light source section to be incident upon the exit pupil.

20. An optical transmitting device, comprising: the decentering optical system according to claim 2; and a light source section which emits a substantially parallel beam.

21. An optical receiving device, comprising: the decentering optical system according to claim 1; and at least one position detection sensor which receives a luminous flux which has been emitted to the exterior of the prism of the decentering optical system, and detects the light reception position thereof.

22. An optical receiving device, comprising:
the decentering optical system according to claim 1;
at least one light reception element which receives a luminous flux which has been emitted to the exterior of the prism of the decentering optical system; and
an input signal controller which is connected to the light reception element.

23. An optical system, comprising:
an optical transmitting device which emits substantially parallel light; and
an optical receiving device, which is disposed so as to confront the optical transmitting device with a certain distance between them, which receives the substantially parallel light as input light, and which comprises the decentering optical system according to claim 1.

24. The optical system according to claim 23, wherein the optical receiving device comprises at least one light reception surface which is a position detection sensor, and the optical system performs optical acquisition and tracking based upon a position signal from the position detection sensor.

25. The optical system according to claim 23, wherein:
the optical transmitting device comprises an output signal controller;
the optical receiving device comprises an input signal controller; and
free space optical communication is performed by modulating a communication signal and sending and receiving it.
